(19) United States
(12) Patent Application Publication
(10) Pub. No.: US 2007/0258006 A1
(43) Pub. Date: Nov. 8, 2007

(54) Solid state camera optics frame and assembly

(76) Inventors: Richard Ian Olsen, Irvine, CA (US); Darryl L. Sato, Irvine, CA (US); Feng-Qing Sun, Irvine, CA (US)

Correspondence Address: COURTNEY STANIFORD & GREGORY LLP, P.O. BOX 9686, SAN JOSE, CA, 95157, US

(21) Appl. No.: 11/788,120

(22) Filed: Apr. 19, 2007

Related U.S. Application Data
(63) Continuation-in-part of application No. 11/212,803, filed on Aug. 25, 2005.
(60) Provisional application No. 60/795,450, filed on Apr. 26, 2006.

(51) Int. Cl. G03B 13/32; G03B 17/00; H04N 5/225

(52) U.S. Cl. 348/345; 348/374; 396/529; 396/89; 348/E05.024

(57) ABSTRACT

Embodiments of a solid-state camera system, particularly an imager module and an associated assembly method are described herein. Embodiments of the imager module include an optics frame configured to accommodate multiple optical channels, each optical channel comprising a lower lens group and an upper lens group. At least one of the lens groups is movable with respect to the other and to image sensors. The imaging sensors may be contained in an imager die. Embodiments further include an assembly method, including an optical configuration and method for mounting and focusing to image sensor microelectronic circuitry. Various embodiments are directed toward packaging microelectronic imagers that are responsive to radiation in the visible light spectrum or radiation in other spectrums to provide a small imager module size suitable for automated manufacture at low cost but are not so limited.

### TECHNICAL FIELD

The following disclosure relates generally to optical devices and more particularly to an optical design and method for mounting and focusing optics to image sensor microelectronic circuitry.

### BACKGROUND

Unlike traditional film cameras that use film to capture and store an image, digital cameras use solid-state microelectronic image sensors to capture an image and digital memory to store the image. These small silicon image sensor chips/die contain thousands to millions of photosensitive detectors called photosites. The combination of a photosite and its circuitry is referred to as a pixel. When the shutter (mechanical/electrical) is open or enabled, each photosite records the intensity or brightness of the incident light by accumulating a charge; the more light, the higher the charge. The brightness and/or color data for a corresponding pixel of the captured image is subsequently read out from the capture circuitry to digitization circuitry and then to digital storage circuitry. Digitization can be accomplished on the imager chip (within the pixel, at each array column, or after row/column multiplexing) or accomplished with analog-to-digital circuitry external to the imager circuitry. The brightness/color digital values can then be used to reconstruct the captured image on a variety of display mechanisms or ink printed paper.

Microelectronic imagers are used in digital cameras, cell phones, Personal Digital Assistants (PDAs), other wired and wireless devices with picture taking (image capture) capabilities, and many other imaging applications. The market for microelectronic imagers has been steadily increasing as they become smaller and produce better images with higher pixel counts. In order to reduce manufacturing cost and size of the entire image sensor, new approaches are required to reduce optics complexity, improve optical performance, simplify and automate optics alignment, and reduce overall component count and size in the final image sensor assembly.

Microelectronic imagers (image sensors) include integrated circuits such as Charged Coupled Device (CCD) image sensors or Complementary Metal-Oxide Semiconductor (CMOS) image sensors. CCD image sensors have been widely used in digital cameras because of their high performance. CMOS image sensors are displacing the CCD in many applications because performance is rapidly improving comparable to the CCD and the high yields of the CMOS fabrication process enable low production costs for each imager chip. CMOS image sensors can provide these advantages because they are manufactured using technology and equipment developed for fabricating standard integrated circuit semiconductor devices. CMOS image sensors, as well as CCD image sensors, are packaged to protect the delicate components, interface with optical components and provide external electrical contacts.

FIG. 1 is a cross-sectional view of a conventional microelectronic imager module 1 with a conventional package and associated optics under the prior art. The imager module 1 includes an integrated circuit die 10, an interposer substrate 20 attached to the die 10, and a housing 30 attached to the interposer substrate 20. The housing 30 surrounds the periphery of the imager die 10 and has an opening 32. The imager module 1 also includes an optically transparent cover 40 over the die 10.

The integrated circuit die 10 includes an image sensor region and associated circuitry 12 and a number of bond-pads 14 electrically coupled to the electrical circuitry 12. The interposer substrate 20 has numerous wire bond-pads 22, bump/solder-pads 24, and traces 26 electrically coupling bond-pads 22 to corresponding bump/solder-pads 24. The bump/solder-pads 24 are arranged in an array for surface mounting the imager 1 to a board or module of another device. The wire bond-pads 14 on the die 10 are electrically coupled to the wire bond-pads 22 on the interposer substrate 20 by wire-bonds 28 to provide electrical pathways between the wire bond-pads 14 and the bump/solder-pads 24.

The imager module 1 also has an optics unit including a support 50 attached to the housing 30 and a barrel 60 adjustably attached to the support 50. The support 50 can include internal threads 52, and the barrel 60 can include external threads 62 engaged with the threads 52. The optics unit also includes an assembly of lenses 70 carried by the barrel 60. The optical focus is achieved by moving all the lenses in unison towards the imaging sensor until optimal performance is achieved.

One problem with packaging a conventional microelectronic imager according to the prior art (e.g. imager module 1) is that the resultant imaging module has a relatively large footprint. The footprint of the imager module 1 for example is the surface area of the bottom of the interposer substrate 20. This is typically much larger than the surface area of the die 10 and can be a limiting factor in the design and marketability of picture cell phones or PDAs because these devices are continually shrinking to be more portable. Therefore, there is a need to provide microelectronic imager modules with smaller footprints.

Another problem with packaging a conventional microelectronic imager is the complexity of the optical assembly and focus mechanism. The optical assembly 70 typically has a diameter significantly larger than the image sensor region 12. The optical assembly is connected to a lens barrel 60 that adds additional diameter size to the imager footprint. The lens barrel 60 has threads 62 that mate with threads 52 on the support 50. These sets of threads align the optics to the image sensor and provided movement in the z-dimension to obtain accurate optical focus and sharpness of image. The precision aligned optic lenses in the assembly 70 are displaced together in the z-direction to adjust the back focal length and focus the imager. The combination of optical assembly 70, barrel 60 and support 50 further increases the diameter size and module footprint. Alignment of the image capture components can be difficult, particularly in small cameras (e.g., cameras in mobile telephones) because multiple devices are mounted on the interposer substrate and the tolerances accumulate to reduce the precision with which the image capture device components can be aligned.

Another issue with conventional imager modules is the lack of a hermetic package. The current modules allow moisture to leak through the threads of the lens barrel, through the housing and/or the substrate causing condensation to form on the sensor or lens and result in a blurring or spotting of the resultant image.

A further issue is that in the conventional imager module, a substrate is used to form a platform for the interconnection of the module assembly and the end product. This is required because the module assembly can not withstand the heat of the solder reflow assembly process.

Yet another issue with conventional imager modules is that the module height is limited by the three basic features: the lens design and resulting stack height; the thickness of the imager; and the substrate thickness/mechanical design. This is especially problematic as the module requires a connector to mate the signal path with the end product. This requires either a connection on the bottom or a flex board to a remote connector. All three features add additional height to a conventional module.

Still another issue with conventional imager modules is the difficulty in accurately aligning the imager to the housing and the finally the lens system. The resulting de-centering significantly degrades the performance of the resultant image. This is particularly difficult to solve as there are many components which have to be aligned in each of six axes.

What is needed, therefore, is an imager module that reduces optical complexity while maintaining high imaging performance, alleviates mechanical alignment problems, requires fewer components, provides smaller overall imager module footprint and less electrical interfaces than prior art solutions. What is also needed is an imager module that requires fewer manufacturing steps, shorter assembly time and lower cost as compared to the prior art.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a cross-sectional view of a conventional microelectronic imager module with a conventional package and associated optics under the prior art.

FIG. 2 is an isometric view of an optics frame of an imager module, under an embodiment.

FIG. 3 is a cross-sectional view of an optics frame, under an embodiment.

FIG. 4 is a cross-sectional view of a lower lens group assembly coupled to an optics frame, under an embodiment.

FIG. 5 is a cross-section of an upper lens group assembly coupled to a lower lens group assembly, under an embodiment.

FIG. 6 is an isometric view of an optics frame attached or coupled to a lower lens group assembly and an upper lens group assembly, under an embodiment.

FIG. 7 is a side view of an imager module that includes an optics frame including a lower lens group assembly and upper lens group assembly in a linear configuration, under an embodiment.

FIG. 8 is an isometric cross-sectional view through one channel of an imager module that includes an optics frame including a lower lens group assembly and upper lens group assembly, under an embodiment.

FIG. 9 is an exploded isometric view of the optics frame including a lower lens group assembly and upper lens group assembly, under an embodiment.

FIG. 10 is a block diagram of a digital camera, under an embodiment.

FIG. 11 is an exploded view of a digital camera subsystem, under an embodiment.

FIG. 12 is a block diagram of a digital camera having a three array/lens configuration, under an embodiment.

FIG. 13 is a block diagram of a digital camera subsystem that employs separate arrays on one image sensor, under an embodiment.

FIG. 14 is a block diagram of arrays, each of which receives a respective color as passed by a respective lens, under an embodiment.

FIG. 15 is a block diagram of processing circuitry of a digital camera subsystem, under an embodiment.

FIG. 16 is a block diagram of signal processing circuitry, under an embodiment.

FIG. 17 is an exploded perspective view of a digital camera, under an embodiment.

FIGS. 18A-18D are schematic exploded representations of one embodiment of an optics portion, under an embodiment.

FIGS. 19A-19C are schematic representations of a sensor array, under an embodiment.

FIG. 20 is a schematic cross-sectional view of a digital camera apparatus, under an embodiment.

FIG. 21 is a schematic perspective view of a digital camera apparatus having one or more optics portions with the capability to provide color separation, under an embodiment.

FIG. 22A is a block diagram of a processor of a digital camera subsystem, under an embodiment.

FIG. 22B is a block diagram of a channel processor of a digital camera subsystem, under an embodiment.

FIG. 22C is a block diagram of an image pipeline of a digital camera subsystem, under an embodiment.

FIG. 22D is a block diagram of an image post processor of a digital camera subsystem, under an embodiment.

FIG. 23 is a block diagram of digital camera system, including system control components, under an embodiment.

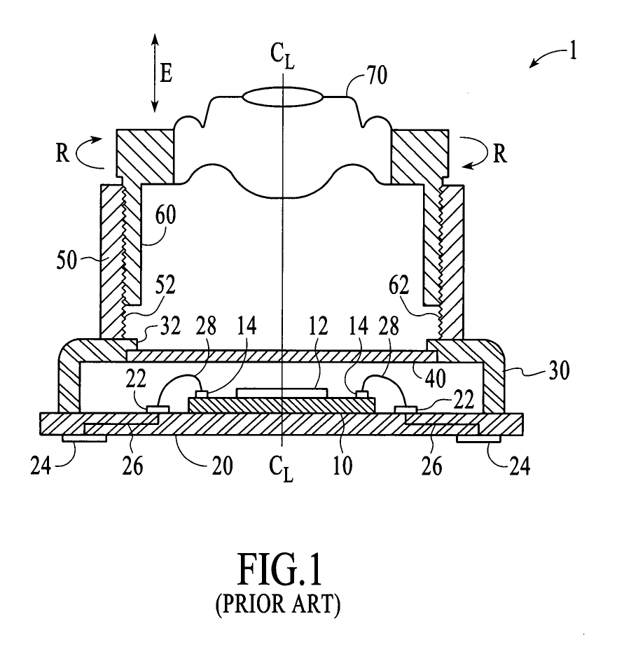

### DETAILED DESCRIPTION

Embodiments of a solid-state camera system, particularly an imager module and an associated assembly method are described herein. Embodiments of the imager module include an optics frame configured to accommodate multiple optical channels, each optical channel comprising a lower lens group and an upper lens group. At least one of the lens groups is movable with respect to the other and to image sensors. The imaging sensors may be contained in an imager die. Embodiments further include an assembly method, including an optical configuration and method for mounting and focusing to image sensor microelectronic circuitry. Various embodiments are directed toward packaging microelectronic imagers that are responsive to radiation in the visible light spectrum or radiation in other spectrums to provide a small imager module size suitable for automated manufacture at low cost but are not so limited.

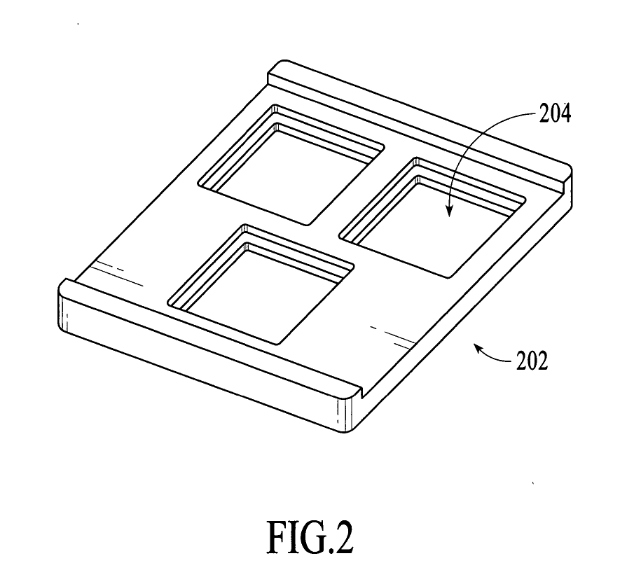

FIG. 2 is an isometric view of an optics frame 202 of an imager module, under an embodiment. In this embodiment, the optics frame 202 includes three openings 204 for each of three separate imaging regions, but is not limited to three openings 204 as alternative embodiments can include any number of openings for any number and/or combination of imaging regions. The openings 204 accommodate imaging channels, each of which includes multiple lens groups, as further described below. The imager module using this optical configuration can be used in a compact solid state camera, for example, but is not so limited.

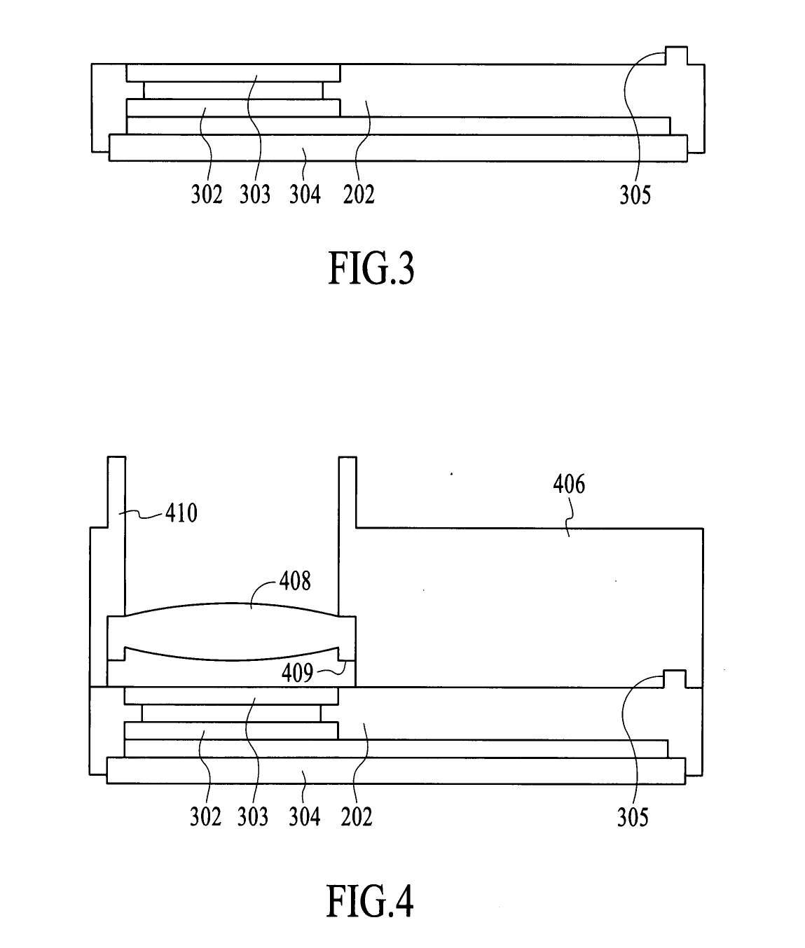

FIG. 3 is a cross-sectional view of the optics frame 202, under an embodiment. The cross-section in this example is taken through an imaging region. The optics frame 202 includes two optical filters 302 and 303. The optics frame 202 and optical filters 302 and 303 are aligned with and attached to an imager integrated circuit (also referred to as an imager die) 304, under an embodiment. The optical configuration of an alternative embodiment may not include optical filters. The optical configuration of another alternative embodiment includes one optical filter, but is not so limited. The optics frame 202 includes an alignment key or reference feature 305 configured for coupling with or attachment of a lower group optical assembly (element 406, for example, shown in FIG. 4). The optics frame 202 can align with one or more edges of the imager integrated circuit 304 or to the imager top surface, for example. The imager integrated circuit 304 can be diced accurately to provide accurate alignment to the integrated circuit edges.

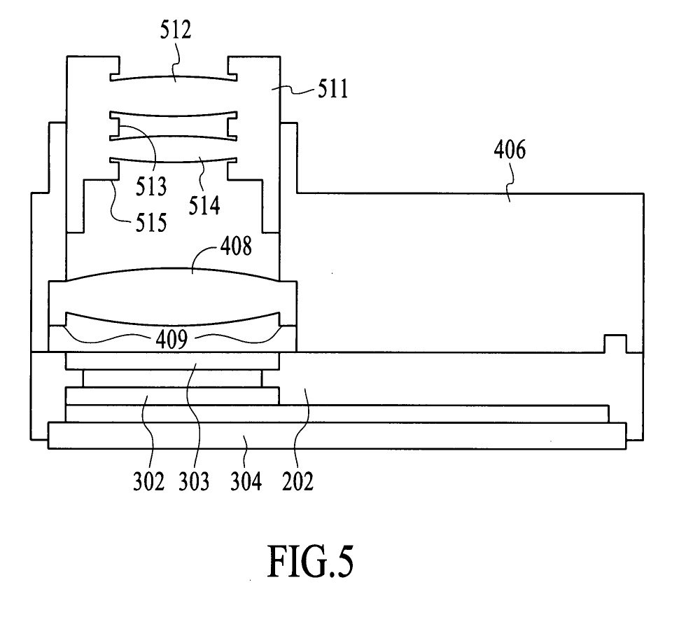

FIG. 4 is a cross-sectional view of a lower lens group assembly 406 coupled to an optics frame 202, under an embodiment. The coupling or attachment uses alignment key 305 as a reference feature but is not so limited. The lower lens group assembly 406 includes a lower lens group 408 and retainer 409 inserted or coupled into the lower portion of a lens barrel 410 under an embodiment. The lower lens group 408 may include one or more optical lenses. In this embodiment, the lower lens group 408 includes one lens, but alternative embodiments can include any number of optical lenses in any of a number of configurations and/or positions in the lower lens group assembly 406. The lower lens group assembly 406 includes the lens barrel 410, which is configured to receive an upper lens group (FIG. 5). An interior surface of the lens barrel 410 can be smooth, or partially or completely threaded to receive the upper lens group assembly via, for example, insertion. The insertion depth of the upper lens group into the lower lens group assembly 406 can be variable in order to support numerous configurations that support focus methods.

FIG. 5 is a cross-section of an imager module, including an upper lens group assembly 511 coupled to a lower lens group assembly 406, under an embodiment. The lower lens group assembly 406 is coupled to an optics frame 202 as described above with reference to FIGS. 3 and 4. The upper lens group assembly 511 includes two lenses 512 and 514 but is not so limited. The upper lens group assembly 511 also includes two retainers 513 and 515 corresponding to respective lenses 512 and 514. The retainers 513 and 515 confine or secure the two lenses 513 and 515 and also function as optical apertures. The upper lens group assembly 511 can include one or more lenses and/or one or more retainers as appropriate to a configuration of the host imager module. The upper lens group assembly 511 of an embodiment is inserted into the lower lens group assembly 406, and the insertion can include sliding or threading mechanisms or devices. The insertion depth of the upper lens group assembly 511 into the lower lens group assembly 406 is variable in and embodiment, in order to support numerous configurations that support focus methods.

In an embodiment, the imager module is assembled by aligning the optical frame 202 with the imager die 304. The optical frame 202 with the imager die 304 are coupled or fixed using any one of various known methods, such as applying a sealant material and curing the material with ultra-violet (UV) radiation, heat, time, etc. The lower lens group assembly 406 is aligned with and similarly coupled to the optical frame 202. The lower lens group 408 may be inserted in the lower lens group assembly 406 before the lower lens group assembly 406 is aligned with and similarly coupled to the optical frame 202, but embodiments are not so limited. The lower lens group 408 is retained with retainers 409.

The upper lens group assembly 511 is inserted in the lens barrel of the lower lens group assembly 406, and the upper lens group assembly 511 is moved along the central axis of the lens barrel so as to achieve an optimal focus with respect to the imager die 304 located below the lower lens group assembly 406. When optimal focus has been achieved, the upper lens group assembly 511 is coupled to the lower lens group assembly 406 so as to fix the position of the upper lens group with respect to the lower lens group. The coupling or fixing can include any known methods, are previously described. In alternative various embodiments, optimal focus is achieved by moving the lower lens group 408 with respect to the upper lens group 512 and 514. As another alternative, both upper and lower lens group assemblies may be movable. In addition, other embodiments may include achieving optimal focus by moving one or more of the lower and upper lens group within its respective lens group assembly.

The upper lens group (lenses 512 and 514) may be inserted in the upper lens group assembly 511 before the upper lens group assembly 511 is aligned with and coupled to the lower lens group assembly 406, but embodiments are not so limited. The upper lens group is retained with retainers 513 and 515.

In an embodiment, coupling or fixing components of the imager module includes providing complete seals between components so as to hermetically seal the upper and lower lens groups in each optical channel. For example, assembling the components of the imager module may be carried out in a desired ambient environment, for example, a very low humidity environment. When the hermetic sealing is complete, each optical channel is maintained in the desired ambient environment, an environment that is close to the desired ambient environment. For example, the hermetic seal prevents moisture from entering the optical channels when the imager module is in a high-humidity environment.

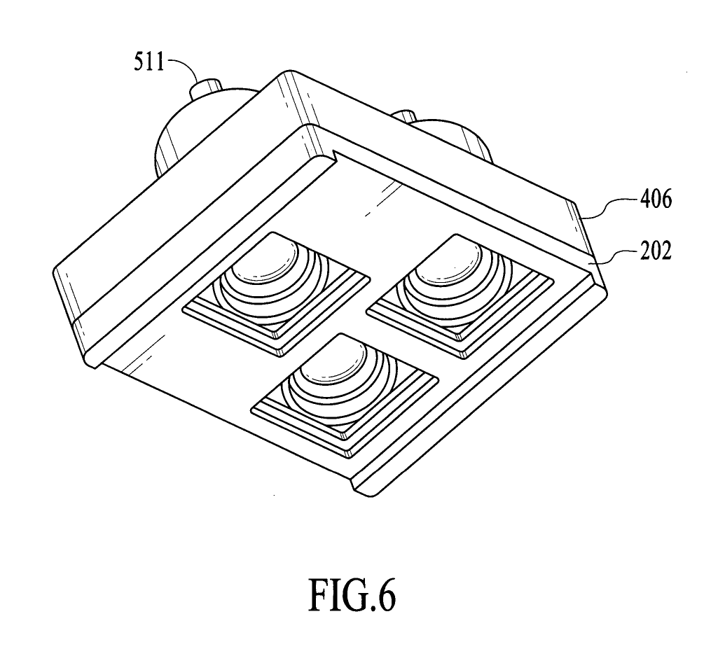

FIG. 6 is an isometric view of an optics frame 202 attached or coupled to a lower lens group assembly 406 and an upper lens group assembly 511, under an embodiment. Each of the optics frame 202, lower lens group assembly 406 and upper lens group assembly 511 are as described above or are similar to the descriptions above with reference to FIGS. 2-5. The imager module formed by the optics frame 202, lower lens group assembly 406, and an upper lens group assembly 511 includes three imaging channels in a triangular configuration but is not so limited. Alternative embodiments of the imager module can include one or more imaging channels. Furthermore, alternative embodiments of the imager module include multiple imaging channels in any number of configurations, for example linear, rectangular, or other configurations.

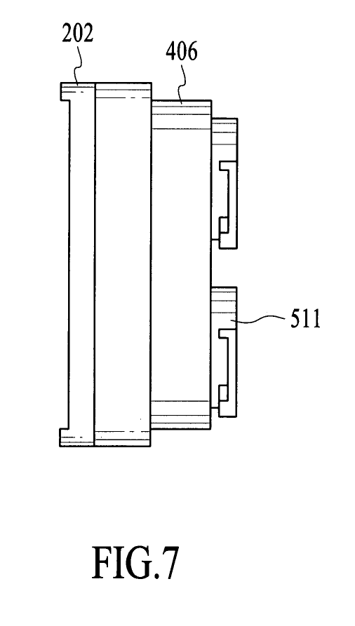

FIG. 7 is a side view of an imager module that includes an optics frame 202 including a lower lens group assembly 406 and upper lens group assembly 511 in a linear configuration, under an embodiment. Each of the optics frame 202, lower lens group assembly 406 and upper lens group assembly 511 are as described above or are similar to the descriptions above with reference to FIGS. 2-5. The embodiment of FIG. 7 includes two imaging channels but is not so limited. Other embodiments can include one or more imaging channels. Alternative embodiments of the imager module include multiple imaging channels in any number of configurations.

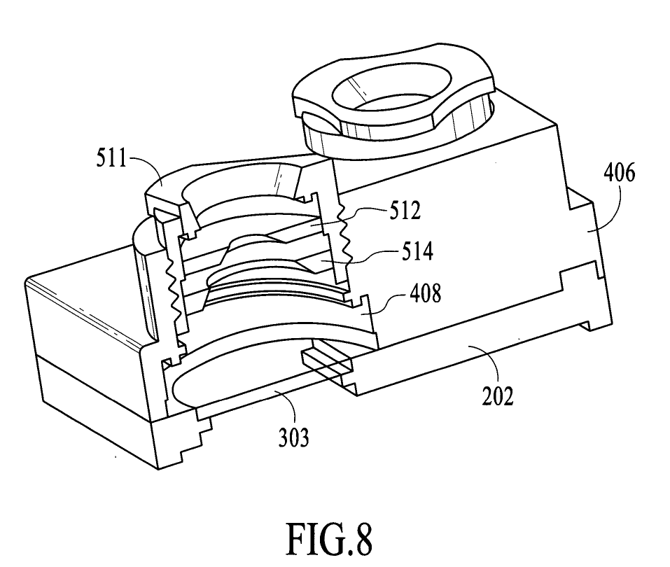

FIG. 8 is an isometric cross-sectional view through one channel of an imager module that includes an optics frame 202 including a lower lens group assembly 406 and upper lens group assembly 511, under an embodiment. Each of the optics frame 202, lower lens group assembly 406 and upper lens group assembly 511 are as described above or are similar to the descriptions above with reference to FIGS. 2-5. In this embodiment a threaded upper lens group insertion method is used to couple or connect each of the upper lens group assemblies 511 in a respective lens barrel. The threaded mechanism also provides focus adjustment. Alternative embodiments can use a sliding insertion mechanism or other insertion methods known in the art.

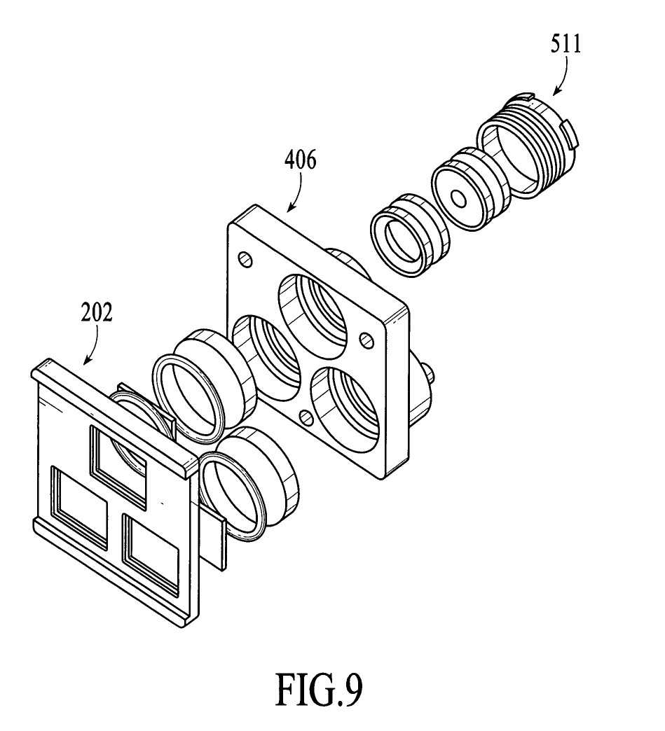

FIG. 9 is an exploded isometric view of the optics frame 202 including a lower lens group assembly 406 and upper lens group assembly 511, under an embodiment. Each of the optics frame 202, lower lens group assembly 406 and upper lens group assembly 511 are as described above or are similar to the description above with reference to FIGS. 2-5. The imager module in this embodiment includes three imaging channels in a triangular configuration but is not limited to three imaging channels or to a triangular channel configuration. The lower lens group assembly 406 in each imaging channel includes one each of the lens, retainer, and optical filter as described above. Other embodiments of the lower lens group assembly 406 can include a different number of lenses, retainers and/or optical filters in any of a number or configurations. Each imaging channel can include, relative to other imaging channels of a host imager module, a unique number of optical lenses. Furthermore, each optical lens of an imaging channel can have a relatively unique configuration and can comprise any of a number of appropriate material compositions as appropriate to the imager module.

Each channel of the imager module can also include a number (e.g. two or less) of optical filters appropriate to the imaging channel spectral characteristics. In FIG. 9, one upper lens group is shown that includes two lenses and two retainers. The upper lens group can include one or more lenses and/or retainers in each imaging channel, and each imaging channel can include a unique numbers of lenses and/or optical properties to match the spectral and imaging characteristics desired in that respective channel. The example of FIG. 9 includes a threaded upper lens group insertion and focus mechanism. Other embodiments can use other upper lens group insertion and focus mechanisms, including sliding mechanisms. The upper lens group insertion depth is independently selected in each channel to provide optimum focus in each imaging channel.

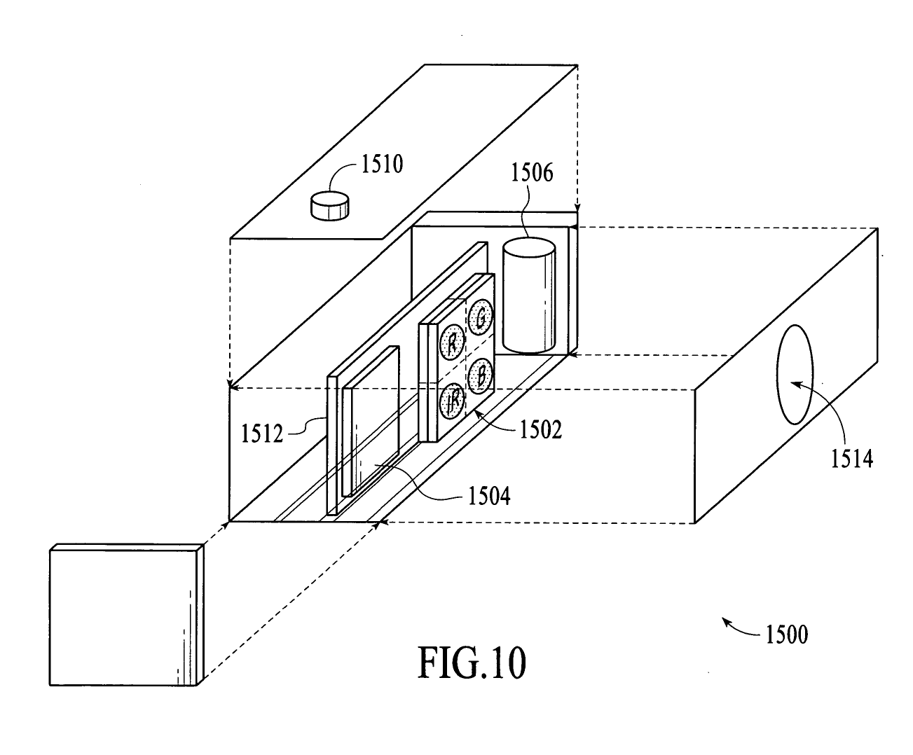

FIGS. 10-23 illustrate further examples of apparatus and systems in which the imaging module embodiments, and imaging module focusing and assembly method embodiments disclosed above can be implemented. FIG. 10 is a block diagram of a digital camera 1500, under an embodiment. The digital camera includes a digital camera subsystem 1502, a circuit board 1512, a peripheral user interface electronics 1510 (here represented as a shutter button, but could also include display and/or one or more other output devices, setting controls and/or one or more additional input devices etc), a power supply 1506, and electronic image storage media 1504. The digital camera 1500 may further include a housing and a shutter assembly (not shown), which controls an aperture 1514 and passage of light into the digital camera 1500.

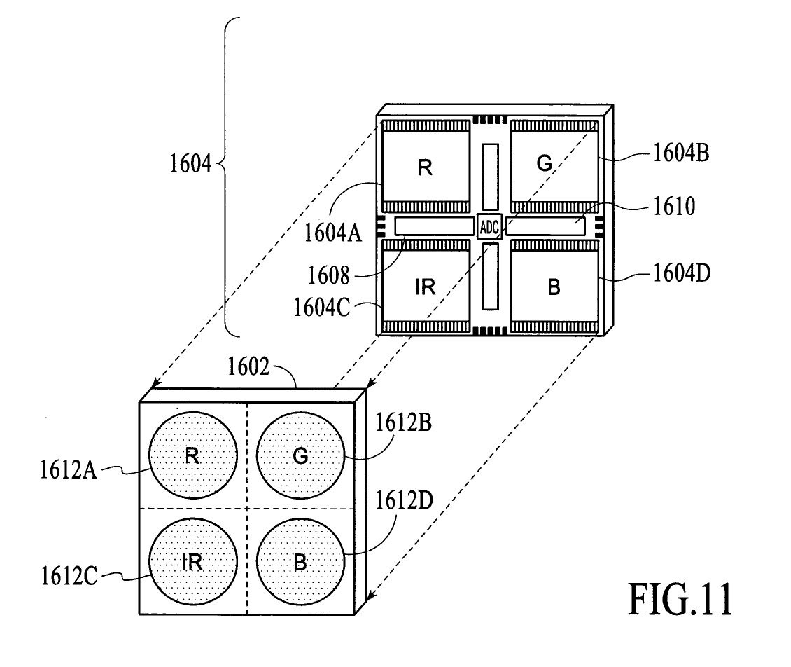

FIG. 11 is an exploded view of the digital camera subsystem 1502, under an embodiment. In this embodiment, the digital camera subsystem includes an image sensor 1604, an optics frame (also referred to as a frame) 1602, and lenses 1612A-1612D. The frame 1602 is used to mount the lenses 612A-1612D to the image sensor 1604. The image sensor, or imager die 1604 generally includes a semiconductor integrated circuit or “chip” having several higher order features including multiple arrays 1604A-1604D and signal processing circuits 1608 and 1610. Each of the arrays 1604A-1604D captures photons and outputs electronic signals. The signal processing circuit 1608, in certain embodiments, processes signals for each of the individual arrays 1604. The signal processing circuit 1610 may combine the output from signal processing 1608 into output data (usually in the form of a recombined full color image). Each array and the related signal processing circuitry may be tailored to address a specific band of visible spectrum.

Each of lenses 1612A-1612D may be tailored for the respective wavelength of the respective array. Lenses are approximately the same size as the underlying array 1604, and will differ from one another in size and shape depending upon the dimensions of the underlying array. In alternative embodiments a lens could cover only a portion of an array, and could extend beyond the array. Lenses can comprise any suitable material or materials, including for example, glass and plastic. Lenses can be doped in any suitable manner, such as to impart a color filtering, polarization, or other property. Lenses can be rigid or flexible.

In the example of FIG. 11, each lens, array, and signal processing circuit constitutes an image generating subsystem for a band of visible spectrum (e.g., red, blue, green, etc). These individual images are then combined with additional signal processing circuitry within the semiconductor chip to form a full image for output.

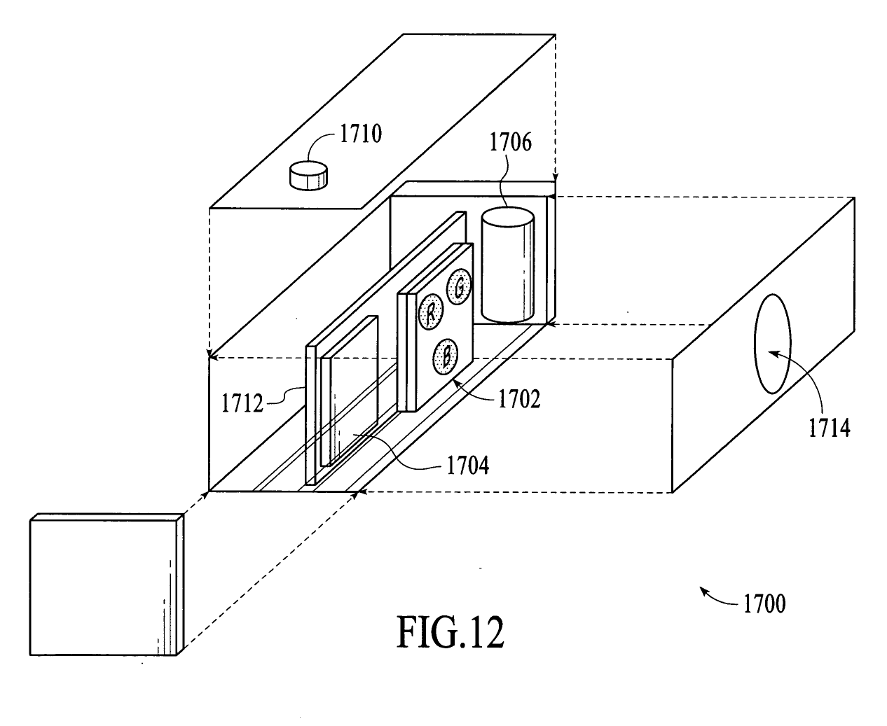

Although the digital camera subsystem 1604 is depicted in a four array/lens configuration, the digital camera subsystem can be employed in a configuration having any number of arrays/lenses and any combination of shapes of arrays/lenses. FIG. 12 is a block diagram of a digital camera 1700 having a three array/lens configuration, under an embodiment. The digital camera 1700 includes a digital camera subsystem 1702 that includes three lenses. The digital camera 1700 further includes a circuit board 1712, a peripheral user interface electronics 1710 (here represented as a shutter button, but could also include display and/or one or more other output devices, setting controls and/or one or more additional input devices etc), a power supply 1706, and electronic image storage media 1704. The digital camera 1700 may further include a housing and a shutter assembly (not shown), which controls an aperture 1714 and passage of light into the digital camera 1700.

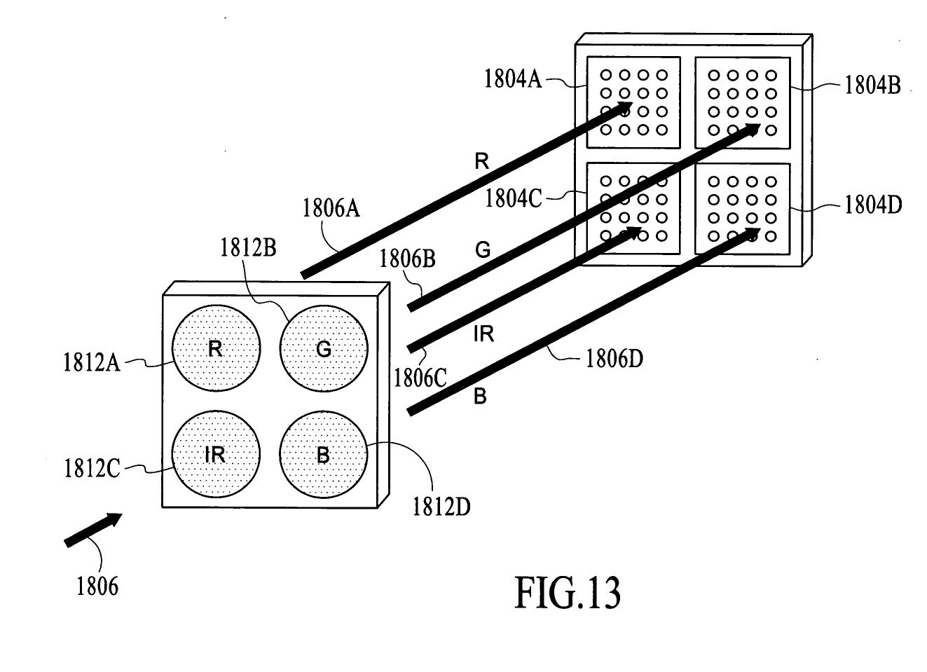

FIG. 13 is a block diagram of a digital camera subsystem that employs separate arrays, e.g., arrays 1804A-1804D, on one image sensor, in contrast to the prior art. For example, typical prior art approaches employ a Bayer pattern (or variations thereof), perform operations across the array (a pixel at a time), and integrate each set of four pixels (for example, red/green/blue/green or variation thereof) from the array into a single full color pixel.

Each of the arrays 1804 focuses on a specific band of visible spectrum. Each lens only needs to pass a respective color (1806A-1806D) on to the image sensor. The traditional color filter sheet is eliminated. Each array 1804 outputs signals to signal processing circuitry. Signal processing circuitry for each of these arrays is also tailored for each of the bands of visible spectrum. In effect, individual images are created for each of these arrays. Following this process, the individual images are combined or to form one full color or black/white image. By tailoring each array and the associated signal processing circuitry, a higher quality image can be generated than the image resulting from traditional image sensors of like pixel count.

As such, each array may be tuned to be more efficient in capturing and processing the image in that particular color. Individual lenses (1812A-D) can be tailored for the array's band of spectrum.

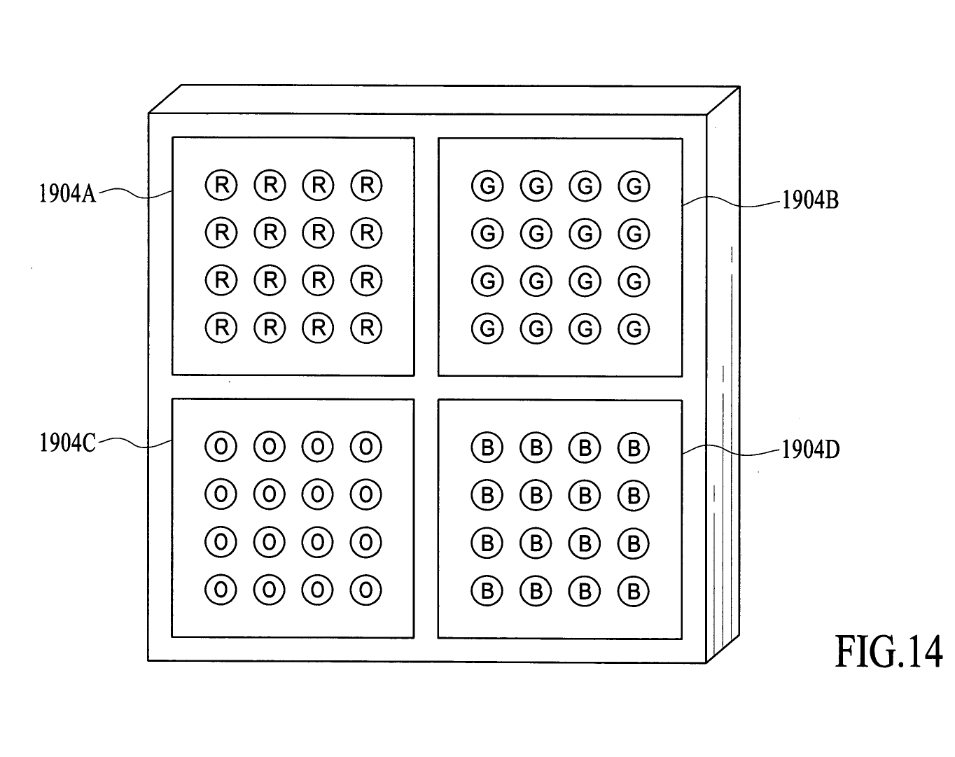

FIG. 14 is a block diagram of arrays 1904A-1904D. Each array 1904 receives a respective color as passed by a respective lens. The traditional color filter sheet is eliminated. Each array 1904 outputs signals to signal processing circuitry. Signal processing circuitry for each of these arrays is also tailored for each of the bands of visible spectrum. In effect, individual images are created for each of these arrays. Following this process, the individual images are combined or to form one full color or black/white image. By tailoring each array and the associated signal processing circuitry, a higher quality image can be generated than the image resulting from traditional image sensors of like pixel count.

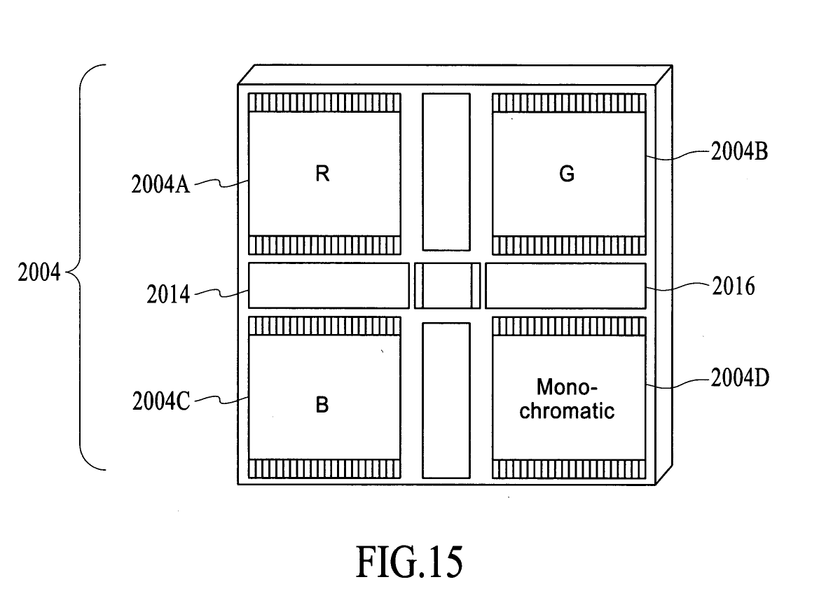

FIG. 15 is a block diagram of processing circuitry of a digital camera subsystem, under an embodiment. FIG. 15 includes an array 2004, including arrays 2004A-2004D, and signal processing circuitry (also referred to as image processing circuitry) 2014 and 2016. Each array outputs signals to signal image circuitry 2014.

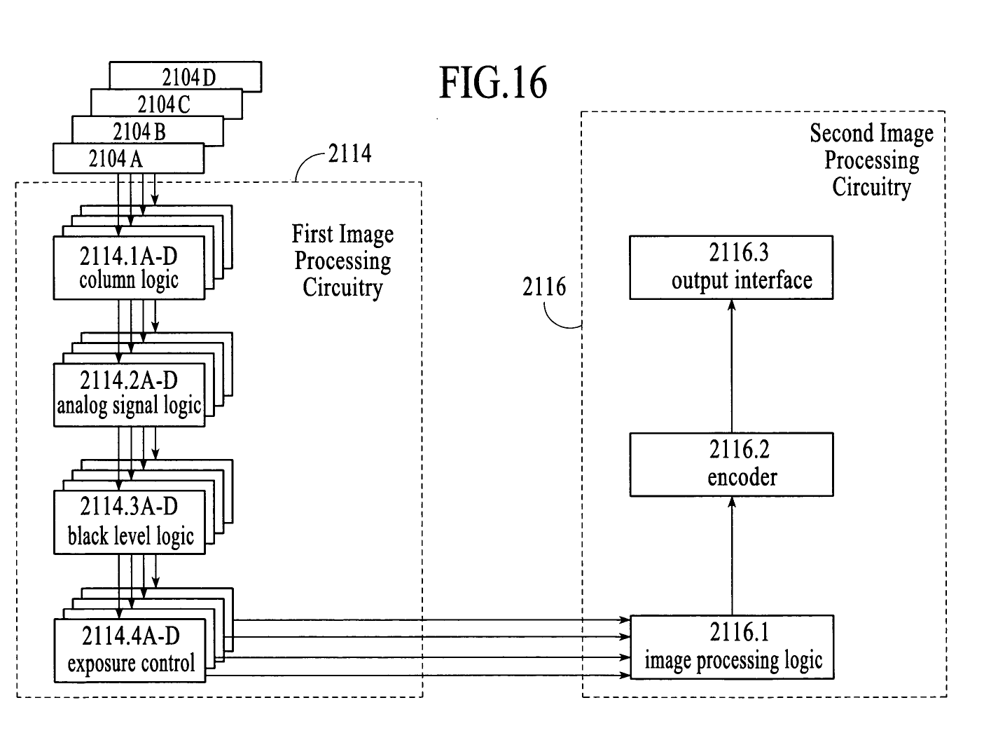

FIG. 16 is a block diagram of image processing circuitry 2014 and 2016. Within the image processing circuitry 2014, each array can be processed separately to tailor the processing to the respective bands of spectrum.

Column logic 2114.1A-2114.1D is the portion of the signal processing circuitry that reads the signals from the pixels. For example, the column logic 2114.1A reads signals from the pixels in array 2104A. Column logic 2114.1B reads signals from the pixels in array 2104B. Column logic 2114.1C reads signals from the pixels in array 2104C. Column logic 2114.1D reads signals from the pixels in array 2104D.

Since an array is targeting a specific wavelength, wavelengths, band of wavelength, or band of wavelengths, the column logic may have different integration times for each array enhancing dynamic range and/or color specificity. Signal processing circuitry complexity for each array can be substantially reduced since logic may not have to switch between extreme color shifts.

Analog Signal Logic (ASL) 2114.2A-2114.2D for each array may be color specific. As such, the ASL processes a single color and therefore can be optimized for gain, noise, dynamic range, linearity, etc. Due to color signal separation, dramatic shifts in the logic and settling time are not required as the amplifiers and logic do not change on a pixel by pixel (color to color) basis as in traditional Bayer patterned designs.

Black level control 2114.3A-2114.3D assesses the level of noise within the signal, and filters it out. With each array focused upon a narrower band of visible spectrum than traditional image sensors, the black level control can be more finely tuned to eliminate noise.

Exposure control 2114.4A-2114.4D measures the overall volume of light being captured by the array and adjusts the capture time for image quality. Traditional cameras must make this determination on a global basis (for all colors). The embodiments describe herein allow for exposure control to occur differently for each array and targeted band of wavelengths.

These processed images are then passed to a second group of signal processing circuitry 2116. First, image processing logic 2116.1 integrates the multiple color planes into a single color image. The image is adjusted for saturation, sharpness, intensity, hue, artifact removal, and defective pixel correction.

In an embodiment, the final two operations include encoding the signal into standard protocols such as MPEG, JPEG, etc. in an encoder 2116.2 before passing the result to a standard output interface 2116.3, such as USB.

Although the signal processing circuitries 2114 and 2116 are shown at specific areas of the image sensor, the signal processing circuitries 2114 and 2116 can be placed anywhere on the chip and subdivided in any fashion. The signal processing circuitries are often placed in multiple locations.

As previously stated, the image sensor 2104 generally includes a semiconductor chip having several higher order features including multiple arrays (2104A-2104D), and signal processing circuitry 2114, in which each array and the related signal processing circuitry is preferably tailored to address a specific band of visible spectrum. As noted above, the image sensor array can be configured using any multiple numbers and shapes of arrays.

The image sensor 2104 can be constructed using any suitable technology, including silicon and germanium technologies. The pixels can be formed in any suitable manner, can be sized and dimensioned as desired, and can be distributed in any desired pattern. Pixels that are distributed without any regular pattern may also be used.

Any range of visible spectrum can be applied to each array depending on the specific interest of the customer. Further, an infrared array could also be employed as one of the array/lens combinations giving low light capabilities to the sensor.

As previously described, arrays 2104A-2104D may be of any size or shape. While some figures referenced herein show the arrays as individual, discrete sections of the image sensor, these arrays may also be touching. There may also be one large array configured such that the array is subdivided into sections, and each section is focused upon one band of spectrum, creating the same effect as separate arrays on the same chip.

Although the well depth of the photo detectors across each individual array 2104 may be the same, the well depth of any given array may be different from that of other arrays of the sensor subsystem. A photo detector includes an area or portion of the photo detector that captures, collects, is responsive to, detects and/or senses the intensity illumination of incident light. In some embodiments, the well depth is the distance from the surface of the photo detector to a doped region.

Selection of an appropriate well depth depends on many factors, including the targeted band of visible spectrum. Since each entire array is likely to be targeted at one band of visible spectrum (e.g., red) the well depth can be configured to capture that wavelength and ignore others (e.g., blue, green). Doping of the semiconductor material in the color specific arrays can further be used to enhance the selectivity of the photon absorption for color-specific wavelengths.

In various embodiments, a digital camera subsystem can have multiple separate arrays on a single image sensor, each with its own lens. The simple geometry of smaller, multiple arrays allows for a smaller lenses (e.g., smaller diameter, thickness and focal length), which allows for reduced stack height in the digital camera.

The lens and frame concept is applicable to traditional image sensors (without the traditional color filter sheet) to gain physical size, cost and performance advantages.

Each array can advantageously be focused on one band of visible and/or detectable spectrum. Among other things, each lens may be tuned for passage of one specific band of wavelength. Since each lens would therefore not need to pass the entire light spectrum, the number of elements may be reduced, for example, to one or two.

Further, due to the focused bandwidth for each lens, each of the lenses may be dyed during the manufacturing process for its respective bandwidth (e.g., red for the array targeting the red band of visible spectrum). Alternatively, a single color filter may be applied across each lens. This process eliminates the traditional color filters (such as the sheet of individual pixel filters) thereby reducing cost, improving signal strength and eliminating the pixel reduction barrier.

The above-described devices can include any suitable number of combinations, including as few as two arrays/lenses, and many more than two arrays/lenses. Examples include: two arrays/lenses configured as red/green and blue; two arrays/lenses configured as red and blue/green; two arrays/lenses configured as red, green, blue; four arrays/lenses configured as red, blue, green, emerald (for color enhancement); four arrays/lenses configured as red, blue, green, infrared (for low light conditions); and eight arrays/lenses configured as double the above configurations for additional pixel count and image quality.

The cameras or camera subsystems described herein are intended to be emblematic of a generic appliance containing the digital camera subsystem. Thus, the description herein should be interpreted as being emblematic of still and video cameras, cell phones, other personal communications devices, surveillance equipment, automotive applications, computers, manufacturing and inspection devices, toys, plus a wide range of other and continuously expanding applications. Of course these alternative interpretations may or may not include the specific components as depicted herein. For example, the circuit board may not be unique to the camera function but rather the digital camera subsystem may be an add-on to an existing circuit board, such as in a cell phone.

Any or all of the methods and/or apparatus disclosed herein may be employed in any type of apparatus or process including, but not limited to still and video cameras, cell phones, other personal communications devices, surveillance equipment, automotive applications, computers, manufacturing and inspection devices, toys, plus a wide range of other and continuously expanding applications.

Although each array and the related signal processing circuitry is can be tailored to address a specific band of visible spectrum, and each lens may be tuned for passage of that one specific band of wavelength, there is no requirement that each such array and the related signal processing circuitry be tailored to address a specific band of the visible spectrum. Nor is there any requirement that each lens be tuned for passage of a specific band of wavelength or that each of the arrays be located on the same semiconductor device. Indeed, the embodiments described and illustrated herein, including the specific components thereof, need not employ wavelength-specific features. For example, the arrays and/or signal processing circuitry need not be tailored to address a specific wavelength or band of wavelengths.

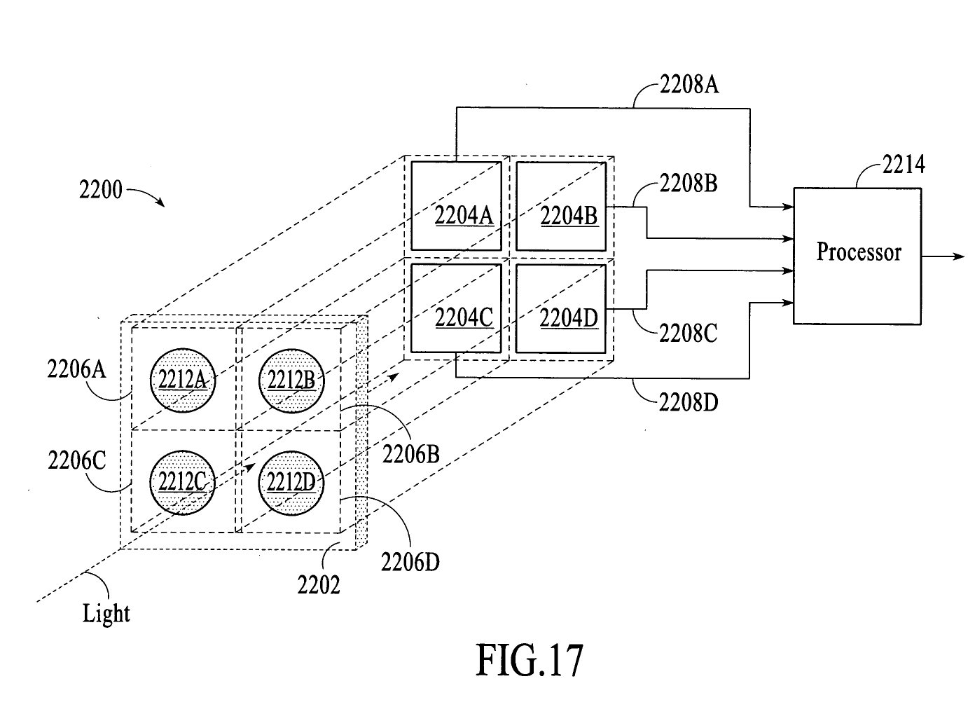

FIG. 17 is an exploded perspective view of a digital camera 2200, under an embodiment. The digital camera apparatus 2200 includes one or more sensor arrays, e.g., four sensor arrays 2204A-2204D, and one or more optics portions, e.g., four optics portions 2212A-2212D. Each of the optics portions 2204A-2204D may include a lens, and may be associated with a respective one of the sensor arrays sensor arrays 2204A-2204D. In some embodiments a support 2202, for example a frame, is provided to support the one or more optics portions 2212A-2212D, at least in part. Each sensor array and the respective optics portion may define an optical channel. For example, an optical channel 2206A may be defined by the optics portion 2212A and the sensor array 2204A. An optical channel 2206B may be defined by the optics portion 2112B and the sensor array 2204B. An optical channel 2206C may be defined by optics portion 2212C and the sensor array 2204C. An optical channel 2206D may be defined by optics portion 2212D and a sensor array 2204D. The optics portions of the one or more optical channels are also collectively referred to as an optics subsystem.

The sensor arrays of the one or more optical channels are collectively referred as a sensor subsystem. The two or more sensor arrays may be integrated in or disposed on a common substrate, referred to as an image device, on separate substrates, or any combination thereof. For example, where the system includes three or more sensor arrays, two or more sensor arrays may be integrated in a first substrate, and one or more other sensor arrays may be integrated in or disposed on a second substrate.

In that regard, the one or more sensor arrays 2204A-2204D, may or may not be disposed on a common substrate. For example, in some embodiments two or more of the sensor arrays are disposed on a common substrate. In some embodiments, however, one or more of the sensor arrays is not disposed on the same substrate as one or more of the other sensor arrays. The one or more optical channels may or may not be identical to one another.

In some embodiments, one of the optical channels 2206 detects red light, one of the optical channels 2206 detects green light, and one of the optical channels 2206 detects blue light. In some of such embodiments, one of the optical channels 2206 detects infrared light, cyan light, or emerald light. In some other embodiments, one of the optical channels 2206 detects cyan light, one of the optical channels 2206 detects yellow light, one of the optical channels 2206 detects magenta light and one of the optical channels 2206 detects clear light (black and white). Any other wavelength or band of wavelengths (whether visible or invisible) combinations can also be used.

A processor 2214 is coupled to the one or more sensor arrays 2204A-2204D, via one or more communication links, e.g., communication links 2208A-2208D, respectively. A communication link may be any kind of communication link including but not limited to, for example, wired (e.g., conductors, fiber optic cables) or wireless (e.g., acoustic links, electromagnetic links or any combination thereof including but not limited to microwave links, satellite links, infrared links), and combinations thereof, each of which may be public or private, dedicated and/or shared (e.g., a network). A communication link may include for example circuit switching or packet switching or combinations thereof. Other examples of communication links include dedicated point-to-point systems, wired networks, and cellular telephone systems. A communication link may employ any protocol or combination of protocols including but not limited to the Internet Protocol.

The communication link may transmit any type of information. The information may have any form, including, for example, but not limited to, analog and/or digital) e.g., a sequence of binary values, or a bit string). The information may or may not be divided into blocks. If divided into blocks, the amount of information in a block may be predetermined or determined dynamically, and/or may be fixed (e.g., uniform) or variable.

As will be further described hereinafter, the processor may include one or more channel processors, each of which is coupled to a respective one (or more) of the optical channels and generates an image based at least in part on the signal(s) received from the respective optical channel, although this is not required. In some embodiments, one or more of the channel processors is tailored to its respective optical channel, for example, as described herein. For example, where one of the optical channels is dedicated to a specific wavelength or color (or band of wavelengths or colors), the respective channel processor may be adapted or tailored to such wavelength or color (or band of wavelengths or colors). Further, the gain, noise reduction, dynamic range, linearity and/or any other characteristic of the processor, or combinations of such characteristics, may be adapted to improve and/or optimize the processor to such wavelength or color (or band of wavelengths or colors). Tailoring the channel processing to the respective optical channel may facilitate generating an image of a quality that is higher than the quality of images resulting from traditional image sensors of like pixel count. In addition, providing each optical channel with a dedicated channel processor may help to reduce or simplify the amount of logic in the channel processors as the channel processor may not need to accommodate extreme shifts in color or wavelength, e.g., from a color (or band of colors) or wavelength (or band of wavelengths) at one extreme to a color (or band of colors) or wavelength (or band of wavelengths) at another extreme.

In operation, an optics portion of a optical channel receives light from within a field of view and transmits one or more portions of such light, e.g., in the form of an image at an image plane. The sensor array receives one or more portions of the light transmitted by the optics portion and provides one or more output signals indicative thereof. The one or more output signals from the sensor array are supplied to the processor. In some embodiments, the processor generates one or more output signals based, at least in part, on the one or more signals from the sensor array. In some other embodiments, the processor may generate a combined image based, at least in part, on the images from two or more of such optical channels.

Although the processor 2214 is shown separate from the one or more sensor arrays 2204A-2204D, the processor 2214, or portions thereof, may have any configuration and may be disposed in one or more locations. For example, certain operations of the processor may be distributed to or performed by circuitry that is integrated in or disposed on the same substrate or substrates as one or more of the one or more of the sensor arrays and certain operations of the processor are distributed to or performed by circuitry that is integrated in or disposed on one or more substrates that are different from (whether such one or more different substrates are physically located within the camera or not) the substrates the one or more of the sensor arrays are integrated in or disposed on.

The digital camera apparatus 2200 may or may not include a shutter, a flash and/or a frame to hold the components together.

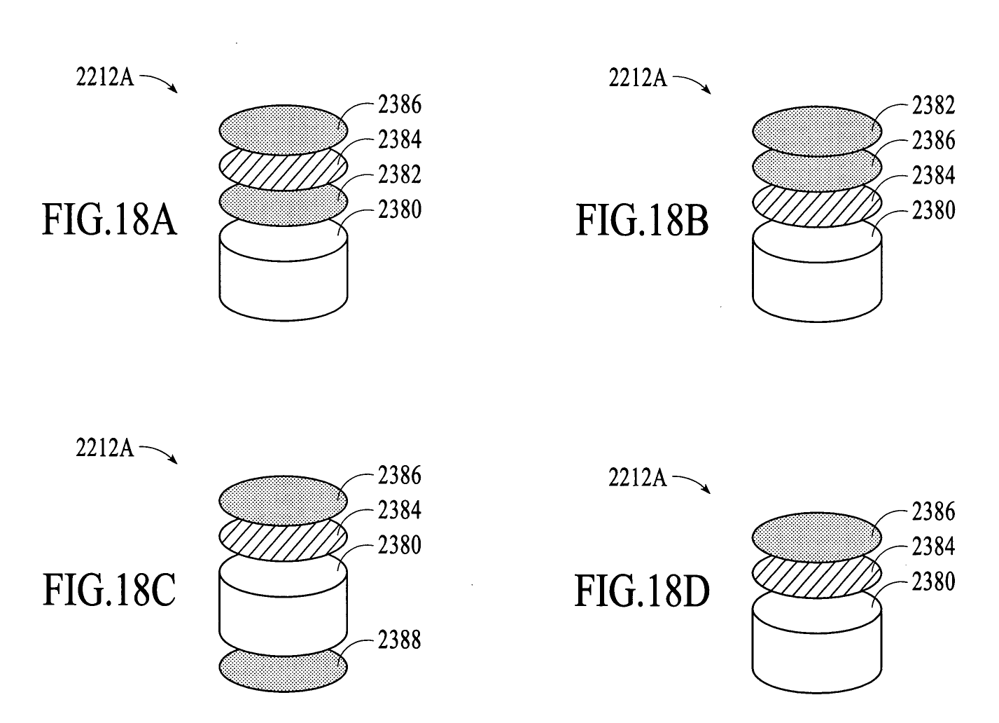

FIGS. 18A-18D are schematic exploded representations of one embodiment of an optics portion, such as optic portion 2212A, under an embodiment. In FIG. 18A, the optics portion 2212A includes one or more lenses, e.g., a complex aspherical lens module 2380, one or more color coatings, e.g., a color coating 2382, one or more masks, e.g., an auto focus mask 2384, and one or more IR coatings, e.g., an IR coating 2386.

Lenses can comprise any suitable material or materials, including for example, glass and plastic. Lenses can be doped in any suitable manner, such as to impart a color filtering, polarization, or other property. Lenses can be rigid or flexible. In this regard, some embodiments employ a lens (or lenses) having a dye coating, a dye diffused in an optical medium (e.g., a lens or lenses), a substantially uniform color filter and/or any other filtering technique through which light passes to the underlying array.

The color coating 2382 helps the optics portion filter (or substantially attenuate) one or more wavelengths or bands of wavelengths. The auto focus mask 2384 may define one or more interference patterns that help the digital camera apparatus perform one or more auto focus functions. The IR coating 2386 helps the optics portion 2212A filter a wavelength or band of wavelength in the IR portion of the spectrum.

The one or more color coatings, e.g., color coating 2382, one or more masks, e.g., mask 2384, and one or more IR coatings, e.g., IR coating 2386 may have any size, shape and/or configuration.

In some embodiments, as shown in FIG. 18B, one or more of the one or more color coatings, e.g., the color coating 2382, are disposed at the top of the optics portion. Some embodiments of the optics portion (and/or components thereof) may or may not include the one or more color coatings, one or more masks and one or more IR coatings and may or may not include features in addition thereto or in place thereof.

In some embodiments, as shown in FIG. 18C, one or more of the one or more color coatings, e.g., the color coating 2382, are replaced by one or more filters 2388 disposed in the optics portion, e.g., disposed below the lens. In other embodiments, as shown in FIG. 18D, one or more of the color coatings are replaced by one or more dyes diffused in the lens.

The one or more optics portions, e.g., optics portions 2212A-2212D of FIG. 17, may or may not be identical to one another. In some embodiments, for example, the optics portions are identical to one another. In some other embodiments, one or more of the optics portions are different, in one or more respects, from one or more of the other optics portions. For example, in some embodiments, one or more of the characteristics (for example, but not limited to, its type of element(s), size, response, and/or performance) of one or more of the optics portions is tailored to the respective sensor array and/or to help achieve a desired result. For example, if a particular optical channel is dedicated to a particular color (or band of colors) or wavelength (or band of wavelengths) then the optics portion for that optical channel may be adapted to transmit only that particular color (or band of colors) or wavelength (or band of wavelengths) to the sensor array of the particular optical channel and/or to filter out one or more other colors or wavelengths. In some of such embodiments, the design of an optical portion is optimized for the respective wavelength or bands of wavelengths to which the respective optical channel is dedicated. It should be understood, however, that any other configurations may also be employed. Each of the one or more optics portions may have any configuration.

In some embodiments, each of the optics portions, e.g., optics portions 2212A-2212D of FIG. 17, comprises a single lens element or a stack of lens elements (or lenslets), although, as stated above. For example, in some embodiments, a single lens element, multiple lens elements and/or compound lenses, with or without one or more filters, prisms and/or masks are employed.

An optical portion can also contain other optical features that are desired for digital camera functionality and/or performance. For example, these features can include electronically tunable filters, polarizers, wavefront coding, spatial filters (masks), and other features not yet anticipated. Some of the features (in addition to the lenses) are electrically operated (such as a tunable filter), or are mechanically movable with MEMs mechanisms.

In some embodiments, one or more photochromic (or photochromatic) materials are employed in one or more of the optical portions. The one or more materials may be incorporated into an optical lens element or as another feature in the optical path, for example, above one or more of the sensor arrays. In some embodiments, photochromatic materials may be incorporated into a cover glass at the camera entrance (common aperture) to all optics (common to all optical channels), or put into the lenses of one or more optical channels, or into one or more of the other optical features included into the optical path of an optics portion over any sensor array.

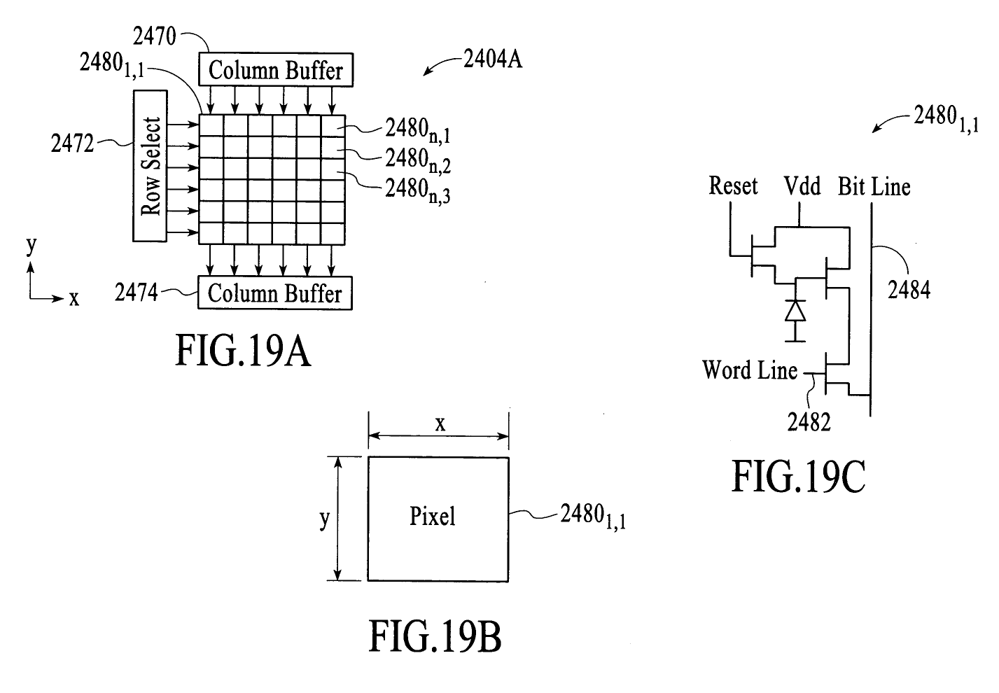

FIGS. 19A-19C are schematic representations of one embodiment of a sensor array 2404. The sensor array is similar to one of the sensor arrays 2204A-2204D of FIG. 17, for example. As shown in FIG. 19A, the sensor array 2404 is coupled to circuits 2470, 2472, and 2474. The sensor array sensor array 2404 captures light and converts it into one or more signals, such as electrical signals, which are supplied to one or more of the circuits 2470, 2472, and 2474. The sensor array 2404 includes a plurality of sensor elements such as for example, a plurality of identical photo detectors (sometimes referred to as “picture elements” or “pixels”), e.g., pixels 2480_{1,1}-2480_{n,m}. The photo detectors 2480_{1,1}-2480_{n,m}, are arranged in an array, for example a matrix-type array. The number of pixels in the array may be, for example, in a range from hundreds of thousands to millions. The pixels may be arranged for example, in a two-dimensional array configuration, for example, having a plurality of rows and a plurality of columns, e.g., 640×480, 1280×1024, etc. However, the pixels can be sized and dimensioned as desired, and can be distributed in any desired pattern. Pixels that are distributed without any regular pattern can also used. Referring to FIG. 19B, a pixel, for example pixel 2480_{1,1}, may be viewed as having x and y dimensions, although the photon capturing portion of a pixel may or may not occupy the entire area of the pixel and may or may not have a regular shape. In some embodiments, the sensor elements are disposed in a plane, referred to herein as a sensor plane. The sensor may have orthogonal sensor reference axes, including for example, an x-axis, a y-axis, and a z-axis, and may be configured so as to have the sensor plane parallel to the x-y plane XY and directed toward the optics portion of the optical channel. Each optical channel has a field of view corresponding to an expanse viewable by the sensor array. Each of the sensor elements may be associated with a respective portion of the field of view.

The sensor array may employ any type of technology, for example, but not limited to MOS pixel technologies (e.g., one or more portions of the sensor are implemented in “Metal Oxide Semiconductor” technology), charge coupled device (CCD) pixel technologies, or combination of both. The sensor array may comprise any suitable material or materials, including, but not limited to, silicon, germanium and/or combinations thereof. The sensor elements or pixels may be formed in any suitable manner.

In operation, the sensor array 2404A, is exposed to light on a sequential line per line basis (similar to a scanner, for example) or globally (similar to conventional film camera exposure, for example). After being exposed to light for certain period of time (exposure time), the pixels 2480_{1,1}-2480_{n,m}, are read out, e.g., on a sequential line per line basis.

In some embodiments, circuitry 2470, also referred to as column logic 2470, is used to read the signals from the pixels 2480_{1,1}-2480_{n,m}. FIG. 19C is a schematic representation of a pixel circuit. The pixels 2480_{1,1}-2480ₙ, also referred to as sensor elements, may be accessed one row at a time by asserting one of the word lines 2482, which run horizontally through the sensor array 2404A. A single pixel 2480_{1,1} is shown. Data is passed into and/or out of the pixel 2480_{1,1} via bit lines (such as bit line 2484) which run vertically through the sensor array 2404A.

The pixels are not limited to the configurations shown in FIGS. 19A-19C. As stated above, each of the one or more sensor arrays may have any configuration (e.g., size, shape, pixel design).

The sensor arrays 2202A-2202D of FIG. 17 may or may not be identical to one another. In some embodiments, for example, the sensor arrays are identical to one another. In some other embodiments, one or more of the sensor arrays are different, in one or more respects, from one or more of the other sensor arrays. For example, in some embodiments, one or more of the characteristics (for example, but not limited to, its type of element(s), size (for example, surface area), and/or performance) of one or more of the sensor arrays is tailored to the respective optics portion and/or to help achieve a desired result.

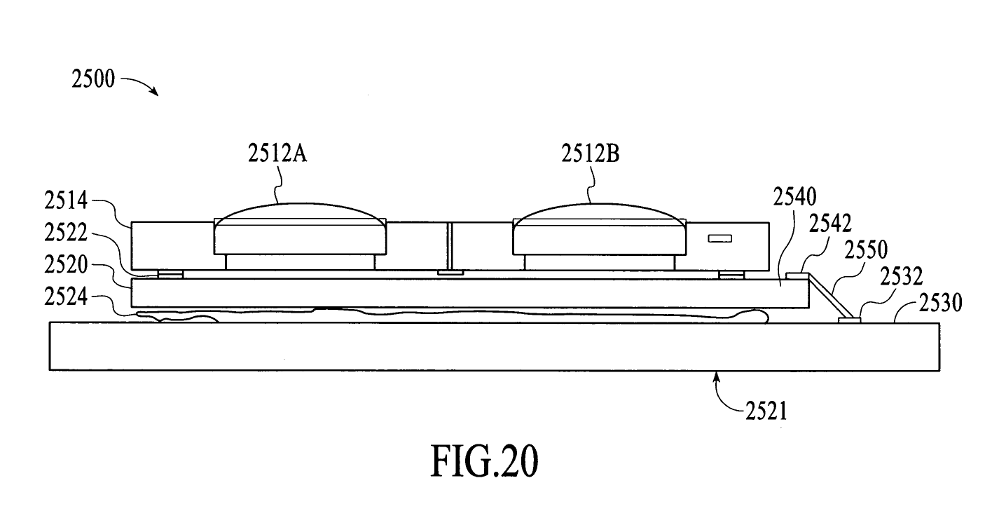

FIG. 20 is a schematic cross-sectional view of a digital camera apparatus 2500 including a printed circuit board 2520 of a digital camera on which the digital camera elements are mounted, under an embodiment. In this embodiment, the one or more optics portions, e.g., optics portions 2512A and 2512B are seated in and/or affixed to a support 2514. The support 2514 (for example a frame) is disposed superjacent a first bond layer 2522, which is disposed superjacent an image device 2520, in or on which sensor portions 2512A-2512D (sensor portions 2512C and 2512D are not shown), are disposed and/or integrated. The image device 2520 is disposed superjacent a second bond layer 2524 which is disposed superjacent the printed circuit board 2521.

The printed circuit board 2521 includes a major outer surface 2530 that defines a mounting region on which the image device 2520 is mounted. The major outer surface 2530 may further define and one or more additional mounting regions (not shown) on which one or more additional devices used in the digital camera may be mounted. One or more pads 2532 are provided on the major outer surface 2530 of the printed circuit board to connect to one or more of the devices mounted thereon.

The image device 2520 includes the one or more sensor arrays (not shown), and one or more electrically conductive layers. In some embodiments, the image device 2520 further includes one, some or all portions of a processor for the digital camera apparatus 2500. The image device 2520 further includes a major outer surface 740 that defines a mounting region on which the support 2514 is mounted.

The one or more electrically conductive layers may be patterned to define one or more pads 2542 and one or more traces (not shown) that connect the one or more pads to one or more of the one or more sensor arrays. The pads 2542 are disposed, for example, in the vicinity of the perimeter of the image device 2520, for example along one, two, three or four sides of the image device 2520. The one or more conductive layers may comprise, for example, copper, copper foil, and/or any other suitably conductive material(s).

A plurality of electrical conductors 2550 may connect one or more of the pads 2542 on the image device 2520 to one or more of the pads 2532 on the circuit board 2521. The conductors 2550 may be used, for example, to connect one or more circuits on the image device 2520 to one or more circuits on the printed circuit board 2521.

The first and second bond layers 2522 and 2524 may comprise any suitable material(s), including but not limited to adhesive, and may comprise any suitable configuration. The first and second bond layers 2522, 2524 may comprise the same material(s) although this is not required. As used herein, a bond layer may be continuous or discontinuous. For example, a conductive layer may be an etched printed circuit layer. Moreover, a bond layer may or may not be planar or even substantially planar. For example, a conformal bond layer on a non-planar surface will be non-planar.

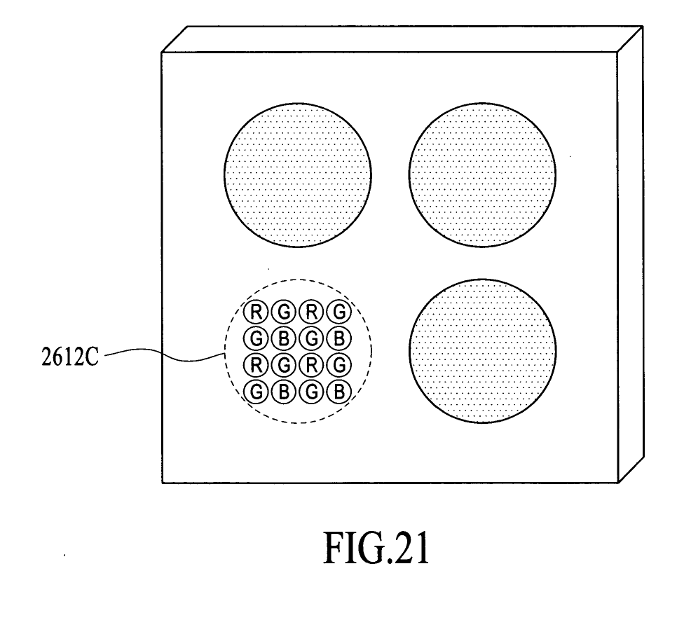

FIG. 21 is a schematic perspective view of a digital camera apparatus having one or more optics portions with the capability to provide color separation in accordance with one embodiment of the present invention. In some of such embodiments, one or more of the optics portions, e.g., optics portion 2612C includes an array of color filters, for example, but not limited to a Bayer patter. In some of such embodiments, one or more of the optics portions, e.g., optics portion 2612C has the capability to provide color separation similar to that which is provided by a color filter array.

In some embodiments, the lens and/or filter of the optical channel may transmit both of such colors or bands of colors, and the optical channel may include one or more mechanisms elsewhere in the optical channel to separate the two colors or two bands of colors. For example, a color filter array may be disposed between the lens and the sensor array, and/or the optical channel may employ a sensor capable of separating the colors or bands of colors. In some of the latter embodiments, the sensor array may be provided with pixels that have multiband capability, e.g., two or three colors. For example, each pixel may comprise two or three photodiodes, wherein a first photodiode is adapted to detect a first color or first band of colors, a second photodiode is adapted to detect a second color or band of colors and a third photodiode is adapted to detect a third color or band of colors. One way to accomplish this is to provide the photodiodes with different structures and/or characteristics that make them selective, such that the first photodiode has a higher sensitivity to the first color or first band of colors than to the second color or band of colors, and the second photodiode has a higher sensitivity to the second color or second band of colors than to the first color or first band of colors. Alternatively, the photodiodes are disposed at different depths in the pixel, taking advantage of the different penetration and absorption characteristics of the different colors or bands of colors. For example, blue and blue bands of colors penetrate less (and are thus absorbed at a lesser depth) than green and green bands of colors, which in turn penetrate less (and are thus absorbed at a lesser depth) than red and red bands of colors. In some embodiments, such a sensor array is employed, even though the pixels may see only one particular color or band of colors, for example, to in order to adapt such sensor array to the particular color or band of colors.

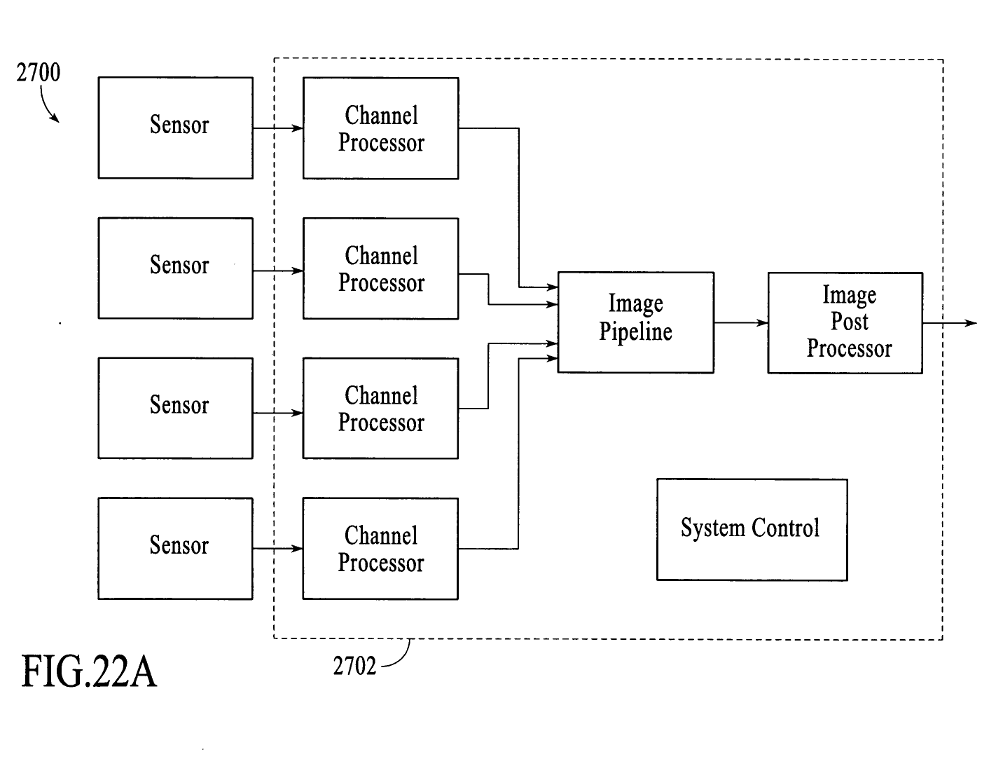

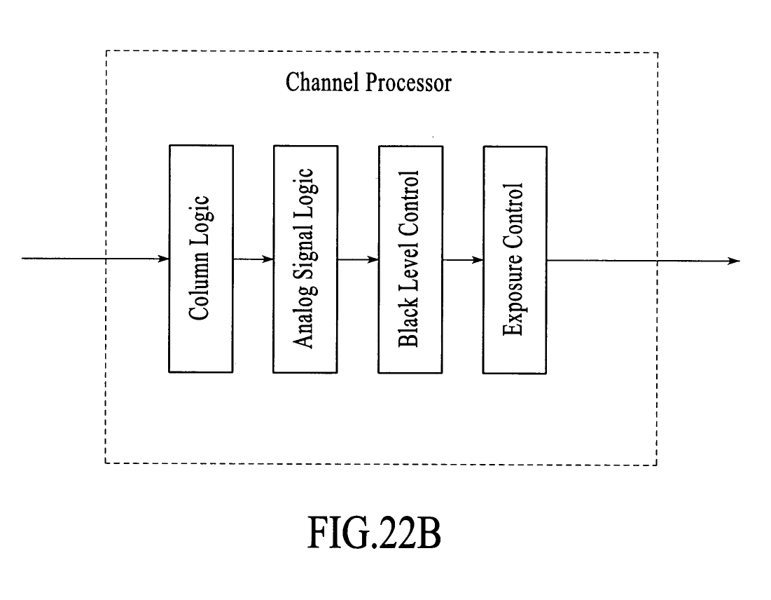

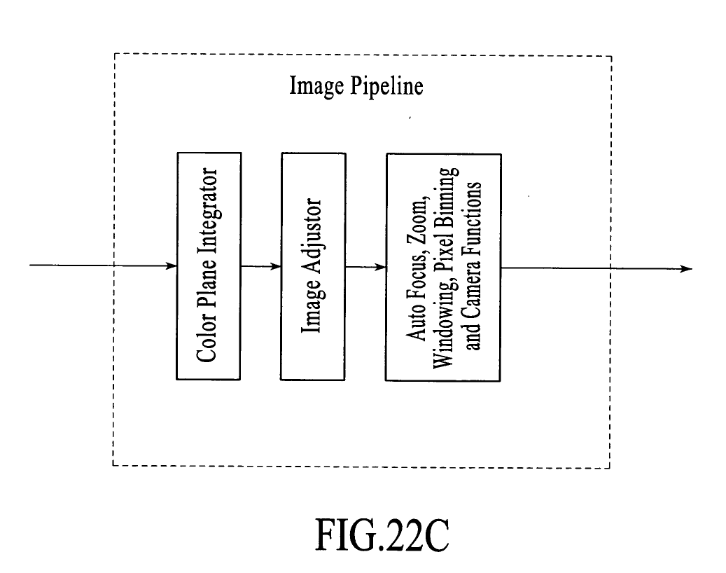

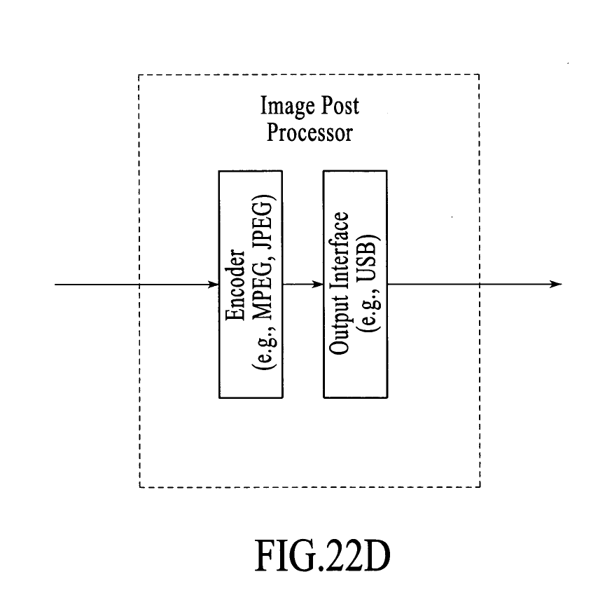

FIG. 22A is a block diagram of a processor 2702 of a digital camera subsystem 2700, under an embodiment. In this embodiment, the processor 2702 includes one or more channel processors, one or more image pipelines, and/or one or more image post processors. Each of the channel processors is coupled to a respective one of the optical channels (not shown) and generates an image based at least in part on the signal(s) received from the respective optical channel. In some embodiments the processor 2702 generates a combined imaged based at least in part on the images from two or more of the optical channels. In some embodiments, one or more of the channel processors are tailored to its respective optical channel, as previously described.

In various embodiments, the gain, noise reduction, dynamic range, linearity and/or any other characteristic of the processor, or combinations of such characteristics, may be adapted to improve and/or optimize the processor to a wavelength or color (or band of wavelengths or colors). Tailoring the channel processing to the respective optical channel makes it possible to generate an image of a quality that is higher than the quality of images resulting from traditional image sensors of like pixel count. In such embodiments, providing each optical channel with a dedicated channel processor helps to reduce or simplify the amount of logic in the channel processors, as the channel processor may not need to accommodate extreme shifts in color or wavelength, e.g., from a color (or band of colors) or wavelength (or band of wavelengths) at one extreme to a color (or band of colors) or wavelength (or band of wavelengths) at another extreme

The images (and/or data which is representative thereof) generated by the channel processors are supplied to the image pipeline, which may combine the images to form a full color or black/white image. The output of the image pipeline is supplied to the post processor, which generates output data in accordance with one or more output formats.

FIG. 22B shows one embodiment of a channel processor. In this embodiment, the channel processor includes column logic, analog signal logic, and black level control and exposure control. The column logic is coupled to the sensor and reads the signals from the pixels. Each of the column logic, analog signal logic, black level control and exposure control can be configured for processing as appropriate to the corresponding optical channel configuration (e.g., specific wavelength or color, etc.). For example, the analog signal logic is optimized, if desired, for processing. Therefore, gain, noise, dynamic range and/or linearity, etc., are optimized as appropriate to the corresponding optical channel configuration (e.g., a specific wavelength or color, etc.). As another example, the column logic may employ an integration time or integration times adapted to provide a particular dynamic range as appropriate to the corresponding optical channel.

The digital camera systems of an embodiment provide digital cameras with large effective single-frame dynamic exposure ranges through the use of multiple camera channels, including multiple optics and image sensors. The multiple camera channels are all configured to image the same field of view simultaneously, and each operates independently under a different integration time. The digital camera can include, for example, a 3×3 assembly of image sensors, perhaps three sensor of each color (e.g., red (R), green (G), and blue (B)) and the integration time of the sensors associated with each color can be varied, for example, each color can have three distinct values (e.g., 0.1 msec, 1 msec, and 10 msec integration time, respectively). The data from all sensors can be digitally combined to provide a much greater dynamic range within one frame of digital camera data. The raw digital camera data could be used by digital signal processing of the scene. The digital data can also be stored and displayed to exhibit low light or bright light characteristics as desired.

Exposure is the total amount of light allowed to fall on a sensor during the process of taking a photograph. Exposure control is control of the total amount of light incident on a sensor during the process of taking a photograph.

In contrast to exposure control, which is used by conventional digital cameras to manage dynamic range, the digital camera systems of an embodiment use integration time control to control the time the electrical signal is integrated on a charge storage device (capacitance) within a sensor (pixel), as described herein. Integration time control, also referred to as “focal plane shutter” control, controls the time the electrical signal is integrated or accumulated by controlling a switch (e.g., charge integration switch) coupled or connected to the sensor or a photo-detection mechanism of a sensor. For example, the charge integration switch is placed in a state to allow charge to accumulate within the sensor for a period of time approximately equal to the integration time corresponding to that sensor; upon completion of the integration period, the switch is placed in a state to transfer the accumulated charge as a photo-signal to a processing component. Digital camera components or circuitry are configured to allow independent control of the charge integration switch associated with each sensor, thereby making possible dynamic range control for each sensor. The integration time control can be executed (depending on readout configuration) according to a number of techniques, for example, rolling mode and/or snap-shot mode to name a few.

The output of the analog signal logic is supplied to the black level control, which determines the level of noise within the signal, and filters out some or all of such noise. If the sensor coupled to the channel processor is focused upon a narrower band of visible spectrum than traditional image sensors, the black level control can be more finely tuned to eliminate noise.

The output of the black level control is supplied to the exposure control, which measures the overall volume of light being captured by the array and adjusts the capture time for image quality. Traditional cameras must make this determination on a global basis (for all colors). In the camera of an embodiment, however, the exposure control can be specifically adapted to the wavelength (or band of wavelengths) to which the sensor is configured. Each channel processor is thus able to provide a capture time that is specifically adapted to the sensor and/or specific color (or band of colors) targeted, and which may be different than the capture time provided by another channel processor for another optical channel.

FIG. 22C is a block diagram of the image pipeline, under an embodiment. In this embodiment, the image pipeline includes two portions. The first portion includes a color plane integrator and an image adjustor. The color plane integrator receives an output from each of the channel processors and integrates the multiple color planes into a single color image. The output of the color plane integrator, which is indicative of the single color image, is supplied to the image adjustor, which adjusts the single color image for saturation, sharpness, intensity and hue. The adjustor also adjusts the image to remove artifacts and any undesired effects related to bad pixels in the one or more color channels. The output of the image adjustor is supplied to the second portion of the pipeline, which provides auto focus, zoom, windowing, pixel binning and camera functions.

FIG. 22D is a block diagram of the image post processor, under an embodiment. In this embodiment, the image post processor includes an encoder and an output interface. The encoder receives the output signal from the image pipeline and provides encoding to supply an output signal in accordance with one or more standard protocols (e.g., MPEG and/or JPEG). The output of the encoder is supplied to the output interface, which provides encoding to supply an output signal in accordance with a standard output interface, e.g., universal serial bus (USB) interface.

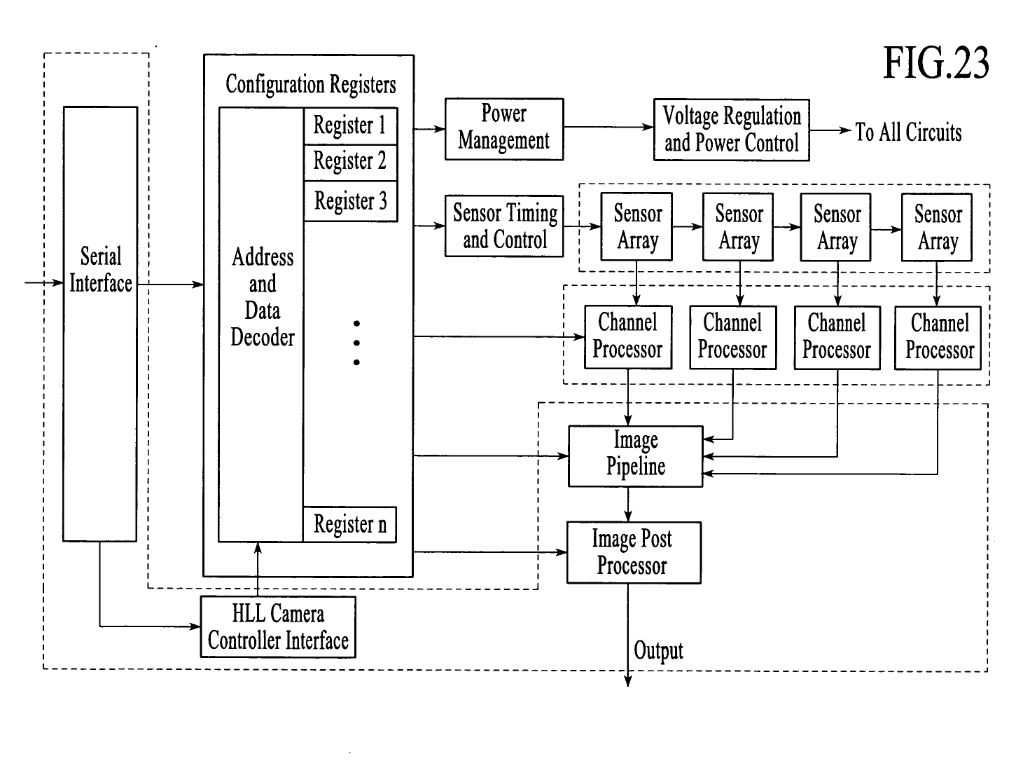

FIG. 23 is a block diagram of digital camera system, including system control components, under an embodiment. The system control portion includes a serial interface, configuration registers, power management, voltage regulation and control, timing and control, a camera control interface and a serial interface, but is not so limited. In some embodiments, the camera interface comprises an interface that processes signals that are in the form of high level language (HLL) instructions. In some embodiments the camera interface comprises an interface that processes control signals that are in the form of low level language (LLL) instructions and/or of any other form now known or later developed. Some embodiments may process both HLL instructions and LLL instructions.

As used herein, the following terms are interpreted as described below, unless the context requires a different interpretation.

“Array” means a group of photodetectors, also know as pixels, which operate in concert to create one image. The array captures photons and converts the data to an electronic signal. The array outputs this raw data to signal processing circuitry that generates the image sensor image output.

“Digital Camera” means a single assembly that receives photons, converts them to electrical signals on a semiconductor device (“image sensor”), and processes those signals into an output that yields a photographic image. The digital camera would included any necessary lenses, image sensor, shutter, flash, signal processing circuitry, memory device, user interface features, power supply and any mechanical structure (e.g. circuit board, housing, etc) to house these components. A digital camera may be a stand-alone product or may be imbedded in other appliances, such as cell phones, computers or the myriad of other imaging platforms now available or to be created in the future, such as those that become feasible as a result of this invention.

“Digital Camera Subsystem” (DCS) means a single assembly that receives photons, converts them to electrical signals on a semiconductor device (“image sensor”) and processes those signals into an output that yields a photographic image. The Digital Camera Subsystem includes any necessary lenses, image sensor, signal processing circuitry, shutter, flash and any frame to hold the components as may be required. The power supply, memory devices and any mechanical structure are not necessarily included.

“Electronic media” means that images are captured, processed and stored electronically as opposed to the use of film.

“Frame” or “thin plate” means the component of the DCS that is used to hold the lenses and mount to the image sensor.

“Image sensor” means the semiconductor device that includes the photon detectors (“pixels”), processing circuitry and output channels. The inputs are the photons and the output is the image data.

“Lens” means a single lens or series of stacked lenses (a column one above the other) that shape light rays above an individual array. When multiple stacks of lenses are employed over different arrays, they are called “lenses.”

“Package” means a case or frame that an image sensor (or any semiconductor chip) is mounted in or on, which protects the imager and provides a hermetic seal. “Packageless” refers to those semiconductor chips that can be mounted directly to a circuit board without need of a package.

The terms “Photo-detector” and “pixels” mean an electronic device that senses and captures photons and converts them to electronic signals. These extremely small devices are used in large quantities (hundreds of thousands to millions) in a matrix to capture an image.

“Semiconductor Chip” means a discrete electronic device fabricated on a silicon or similar substrate, which is commonly used in virtually all electronic equipment.

“Signal Processing Circuitry” means the hardware and software within the image sensor that translates the photon input information into electronic signals and ultimately into an image output signal.

Embodiments of a solid state camera optics frame and assembly method include an imager module comprising: an optics frame configured to accommodate multiple imaging channels wherein the multiple imaging channels are each oriented substantially orthogonal to an imager die; and at least one imaging channel configured to couple with the optics frame substantially orthogonal to the imager die, wherein each imaging channel comprises at least two lens groups, positioned at different distances from the imager die along a central axis of the imaging channel, wherein at least one of the lens groups is movable with respect to at least one other lens group to focus the imaging channel.

In an embodiment, the optics frame is coupled to the imager die.

In an embodiment, the optics frame is coupled to edges of the imager die.

In an embodiment, the optics frame is coupled to a top surface of the imager die.

In an embodiment, the imager module further comprises at least one optical filter coupled to the optical frame in at least one of the optical channels.

In an embodiment, each imaging channel comprises a lower lens group and an upper lens group, wherein the lower lens group is closer to the imager die than the upper lens group.

In an embodiment, the optics frame further comprises a mechanical reference feature for alignment and coupling of a lower lens group assembly, wherein the lower lens group assembly comprises a lower lens group for each imaging channel.

In an embodiment, the lower lens group assembly is a fixed distance from the imager die.

In an embodiment, each upper lens group is movable with respect to a lower lens group in a same channel.

In an embodiment, the imager module further comprises: a lower lens group assembly coupled to the optics frame and configured to retain a lower lens group in each imaging channel; and an upper lens group assembly coupled to the lower lens group assembly and configured to allow movement of an upper lens group with respect to a respective lower lens group in each imaging channel.

In an embodiment, the upper lens group assembly is moveably coupled to a lens barrel of the lower lens group assembly to allow movement of each upper lens group toward and away from a lower lens group in a same imaging channel to determine a position that provides optimum focus in the imaging channel.

In an embodiment, the upper lens group assembly is slidably coupled to the lens barrel.

In an embodiment, the upper lens group assembly is rotatably coupled to the lens barrel.

In an embodiment, the upper lens group assembly and the lens barrel comprise mating threads.

In an embodiment, each upper lens group includes one or more lenses, and wherein each lower lens group includes one or more lenses.

Embodiment disclosed herein further include a method for assembling an imaging module, the method comprising: assembling a lower lens group assembly, comprising coupling a lower lens group into the lower lens group assembly for each of a plurality of optical channels; inserting an upper lens group assembly into a lens barrel of the lower lens group assembly such that an upper lens group of the upper lens group assembly is positioned above the lower lens group, and wherein the upper lens group and the lower lens group are substantially centered about a central axis of the lens barrel; and moving at least one of the upper lens group and the lower lens group along the central axis of the lens barrel so as to achieve an optimal focus with respect to an imager die located below the lower lens group.

In an embodiment, the method further comprises fixing the upper lens group assembly in place when the optimal focus has been achieved.

In an embodiment, fixing comprises creating a hermetic seal between the upper lens group assembly and the lower lens group assembly.

In an embodiment, moving at least one of the upper lens group and the lower lens group comprises moving the upper lens group with respect to the lower lens group.

In an embodiment, moving at least one of the upper lens group and the lower lens group comprises moving the upper lens group assembly with respect to the lower lens group assembly.

In an embodiment, moving comprises sliding the upper lens group assembly in the lens barrel.

In an embodiment, moving comprises rotating the upper lens group assembly in the lens barrel.

In an embodiment, the upper lens group assembly and the lens barrel comprise mating threads.

In an embodiment the method further comprises: inserting the upper lens group in the upper lens group assembly, wherein the upper lens group comprises at least one optical lens; and fixing the upper lens group in the upper lens group assembly, comprising inserting retainers in the upper lens group assembly.

In an embodiment the method further comprises: inserting the lower lens group in the lower lens group assembly, wherein the lower lens group comprises at least one optical lens; and fixing the lower lens group in the lower lens group assembly, comprising inserting retainers in the lower lens group assembly.

In an embodiment the method further comprises coupling the lower lens group assembly to an optical frame, wherein the optical frame comprises openings corresponding to each of the plurality of optical channels.

In an embodiment, coupling comprises creating a hermetic seal between the lower lens group assembly and the optical frame.

In an embodiment, the method further comprises aligning the optical frame with the imager die.

In an embodiment, the method further comprises: dicing the imager die to provide accurate alignment of an optical frame to edges of the imager die; aligning the optical frame with the imager die; and coupling the lower lens group assembly to the imager die.

In an embodiment, coupling comprises creating a hermetic seal between the lower lens group assembly and the imager die.

In an embodiment, the method further comprises: fixing the upper lens group assembly in place when the optimal focus has been achieved; and hermetically sealing the plurality of optical channels.

Embodiments described herein further comprise an imager module produced according to the methods described herein.

Embodiments described herein further comprise a solid-state camera system produced according to the methods described herein.

Aspects of the solid state camera system and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the solid state camera system include: microcontrollers with memory (such as electronically erasable programmable read only memory (EEPROM)), embedded microprocessors, firmware, software, etc. Furthermore, aspects of the solid state camera system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various circuits disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and HLDL, formats supporting register level description languages like RTL, and formats supporting geometry description languages such as GDSII, GDSIII, GDSIV, CIF, MEBES and any other suitable formats and languages. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the solid state camera systems and methods is not intended to be exhaustive or to limit the solid state camera systems and methods to the precise form disclosed. While specific embodiments of, and examples for, the solid state camera systems and methods are described herein for illustrative purposes, various equivalent modifications are possible within the scope of the solid state camera systems and methods, as those skilled in the relevant art will recognize. The teachings of the solid state camera systems and methods provided herein can be applied to other processing systems and methods, not only for the systems and methods described above.

The elements and acts of the various embodiments described above can be combined to provide further embodiments. These and other changes can be made to the solid state camera systems and methods in light of the above detailed description.

What is claimed is:

1. An imager module comprising:
an optics frame configured to accommodate multiple imaging channels wherein the multiple imaging channels are each oriented substantially orthogonal to an imager die; and
at least one imaging channel configured to couple with the optics frame substantially orthogonal to the imager die, wherein each imaging channel comprises at least two lens groups, positioned at different distances from the imager die along a central axis of the imaging channel, wherein at least one of the lens groups is movable with respect to at least one other lens group to focus the imaging channel.

2. The imager module of claim 1, wherein the optics frame is coupled to the imager die.

3. The imager module of claim 1, wherein the optics frame is coupled to edges of the imager die.

4. The imager module of claim 1, wherein the optics frame is coupled to a top surface of the imager die.

5. The imager module of claim 1, further comprising at least one optical filter coupled to the optical frame in at least one of the optical channels.

6. The imager module of claim 1, wherein each imaging channel comprises a lower lens group and an upper lens group, wherein the lower lens group is closer to the imager die than the upper lens group.

7. The imager module of claim 6, wherein the optics frame further comprises a mechanical reference feature for alignment and coupling of a lower lens group assembly, wherein the lower lens group assembly comprises a lower lens group for each imaging channel.

8. The imager module of claim 7, wherein the lower lens group assembly is a fixed distance from the imager die.

9. The imager module of claim 8, wherein each upper lens group is movable with respect to a lower lens group in a same channel.

10. The imager module of claim 1, further comprising:
a lower lens group assembly coupled to the optics frame and configured to retain a lower lens group in each imaging channel; and
an upper lens group assembly coupled to the lower lens group assembly and configured to allow movement of an upper lens group with respect to a respective lower lens group in each imaging channel.

11. The imager module of claim 10, wherein the upper lens group assembly is moveably coupled to a lens barrel of the lower lens group assembly to allow movement of each upper lens group toward and away from a lower lens group in a same imaging channel to determine a position that provides optimum focus in the imaging channel.

12. The imager module of claim 11, wherein the upper lens group assembly is slidably coupled to the lens barrel.

13. The imager module of claim 11, wherein the upper lens group assembly is rotatably coupled to the lens barrel.

14. The imager module of claim 13, wherein the upper lens group assembly and the lens barrel comprise mating threads.

15. The imager module of claim 10, wherein each upper lens group includes one or more lenses, and wherein each lower lens group includes one or more lenses.

16. A method for assembling an imaging module, the method comprising:
assembling a lower lens group assembly, comprising coupling a lower lens group into the lower lens group assembly for each of a plurality of optical channels;
inserting an upper lens group assembly into a lens barrel of the lower lens group assembly such that an upper lens group of the upper lens group assembly is positioned above the lower lens group, and wherein the upper lens group and the lower lens group are substantially centered about a central axis of the lens barrel; and
moving at least one of the upper lens group and the lower lens group along the central axis of the lens barrel so as to achieve an optimal focus with respect to an imager die located below the lower lens group.

17. The method of claim 16, further comprising fixing the upper lens group assembly in place when the optimal focus has been achieved.

18. The method of claim 17, wherein fixing comprises creating a hermetic seal between the upper lens group assembly and the lower lens group assembly.

19. The method of claim 16, wherein moving at least one of the upper lens group and the lower lens group comprises moving the upper lens group with respect to the lower lens group.

20. The method of claim 16, wherein moving at least one of the upper lens group and the lower lens group comprises moving the upper lens group assembly with respect to the lower lens group assembly.

21. The method of claim 20, wherein moving comprises sliding the upper lens group assembly in the lens barrel.

22. The method of claim 20, wherein moving comprises rotating the upper lens group assembly in the lens barrel.

23. The method of claim 22, wherein the upper lens group assembly and the lens barrel comprise mating threads.

24. The method of claim 16, further comprising:
inserting the upper lens group in the upper lens group assembly, wherein the upper lens group comprises at least one optical lens; and
fixing the upper lens group in the upper lens group assembly, comprising inserting retainers in the upper lens group assembly.

25. The method of claim 16, further comprising:
inserting the lower lens group in the lower lens group assembly, wherein the lower lens group comprises at least one optical lens; and
fixing the lower lens group in the lower lens group assembly, comprising inserting retainers in the lower lens group assembly.

26. The method of claim 16, further comprising coupling the lower lens group assembly to an optical frame, wherein the optical frame comprises openings corresponding to each of the plurality of optical channels.

27. The method of claim 26, wherein coupling comprises creating a hermetic seal between the lower lens group assembly and the optical frame.

28. The method of claim 26, further comprising aligning the optical frame with the imager die.

29. The method of claim 16, further comprising:
dicing the imager die to provide accurate alignment of an optical frame to edges of the imager die;
aligning the optical frame with the imager die; and
coupling the lower lens group assembly to the imager die.

30. The method of claim 29, wherein coupling comprises creating a hermetic seal between the lower lens group assembly and the imager die.

31. The method of claim 16, further comprising:
fixing the upper lens group assembly in place when the optimal focus has been achieved; and
hermetically sealing the plurality of optical channels.

32. An imager module produced according to the method of claim 16.

33. A solid-state camera system produced according to the method of claim 16.
